(19) United States
(12) Patent Application Publication
(10) Pub. No.: US 2026/0029526 A1
(43) Pub. Date: Jan. 29, 2026

(54) MICROWAVE IMAGING RADAR SENSOR

(71) Applicant: BEA SA, Angleur (BE)

(72) Inventors: Vincent KASCHTEN, Angleur (BE); Alain Louis ZAMBON, Saint-Nicolas (BE)

(21) Appl. No.: 19/150,002

(22) PCT Filed: Jan. 26, 2024
(86) PCT No.: PCT/EP2024/051925

§ 371 Date: Jul. 22, 2025

(30) Foreign Application Priority Data
Jan. 27, 2023 (DE) 10 2023 102 084.6

(51) Int. Cl. G01S 13/89; G01S 7/02; G01S 7/03; G01S 7/35; G01S 13/42

(52) U.S. Cl. CPC G01S 13/89; G01S 7/028; G01S 7/032; G01S 7/35; G01S 13/426

(57) ABSTRACT

A microwave imaging radar sensor for creating an image of at least a part of its surrounding space includes at least one transmitter unit, a receiver unit and an evaluation unit having an output port to output an image connected to the transmitter and receiver units. The image has fields related to a pair of a transmit channel and a receive channel, where at least two transmit channels and at least two receive channels each correspond to a fan shaped beam having a first dimension (D1) which is significantly larger than and perpendicular to a second dimension (D2). The field is assigned to a radar result characteristic (RC) provided by the receive channel whose fan shaped receive beam overlaps with the fan shaped transmit beam of the transmit channel defining an overlap area. The transmit channel correlates with the transmitter unit, which comprises a refractive beamformer having a transmit reference plane to which the fan shaped transmit beams of the transmit channels are perpendicular with their first dimension (D1). The transmitter unit embodies transmit transition structures associated with the refractive beamformer at different transition positions, so that each transmit channel is related to at least one transmit transition structure. The receive channel correlates with the receiver unit that has a refractive beamformer having a receive reference plane to which the fan shaped receive beams of the receive channels are perpendicular with their first dimension (D1). The receiver unit includes receive transition structures associated with the refractive beamformer at different transition positions, so that each receive channel is related to at least one receive transition structure.

This application is the US national stage of PCT Application No. PCT/EP2024/051925 filed Jan. 26, 2024, which claims priority to German Patent Application No. 10 2023 102 084.6 filed Jan. 27, 2023, both of which are hereby incorporated by reference in their entireties.

The invention refers to a microwave imaging radar sensor for creating an image of at least a part of a surrounding space close to the sensor according to the preamble of claim 1.

The document US 2010 0141 527 A1 discloses a radar sensor comprising an orthogonal antenna system, where at least one transmit aperture produces a transmit beam and at least one receive aperture is associated with a receive beam. The transmit aperture is substantially orthogonal to the corresponding receive aperture, thereby producing a cross-product of the two orthogonal apertures. The transmit beam is narrow in a first dimension and wide in a second dimension, and the receive beam is wide orthogonally to the first dimension and narrow orthogonally to the second dimension. The transmit signal is reflected from an object and is received by the orthogonal array, such that the 2-way transfer function results in a cross-product of two antenna patterns, one being vertical and one horizontal. The intersection of the transmit beam with the receive beam results in a composite narrow beam cross-product.

The document US 2014 0176 377 A1 shows an antenna system having a cylindrical electromagnetic lens configured to guide at least one electromagnetic signal to an emerging area by means of at least a variation in dielectric permittivity, thereby generating a beam output from the emerging area. The antenna system has a dielectric member configured to receive the beam output from the emerging area and to focus the beam in an elevation plane perpendicular to a planar face of the cylindrical electromagnetic lens. The cylindrical electromagnetic lens is received in a conductive mounting, and the mounting carries the dielectric member.

The document WO 2018 035 148 A1 discloses a radar application using a 3D printed spherical Luneburg lens for beam steering. Receivers are mounted around the lens, such that the antenna radiation pattern is maintained for all angles without beam deformation. The radar adaptively adjusts its spatial sensing pattern, sweeping frequency band, pulse repetition frequency and coherent processing interval according to the environment. This is accomplished by initially performing a rough scan, which updates sensing results via a narrow bandwidth waveform and wide beam scanning. When objects of interest are identified, a high-resolution detailed scan is performed in a specific region of interest. A method of mitigating interference of the 3D printed Luneburg lens-based radar and a method of improving the angle resolution using a lens-based MIMO approach is disclosed.

The document US 2008 0055 175 A1 shows a multibeam antenna comprising at least one electromagnetic lens and a plurality of transition structures with antenna feed elements on a dielectric substrate. They are adapted to launch or receive electromagnetic waves in or from a direction substantially away from either a convex or concave edge of the dielectric substrate. At least two of the antenna elements operate in different directions.

It is object of the invention to provide a microwave imaging radar sensor which can provide an image of at least a part of its surrounding space fast and with a low effort on analysis.

The object is solved by a microwave radar sensor according to claim 1.

The subclaims are advantageous embodiments of the invention.

The invention refers to a microwave imaging radar sensor for creating an image of at least a part of its surrounding space. The sensor can be used to detect an object which is within a range of less than 200 m of the sensor, in particular about 20 m.

The microwave imaging radar sensor comprises at least one transmitter unit, a receiver unit and an evaluation unit. The evaluation unit is connected to both the transmitter unit and the receiver unit which respectively generate a plurality of transmit and receive beams.

The evaluation unit has an output port to output an image of at least a part of the surrounding space of the microwave imaging radar sensor. The image comprises a multitude of fields. Each field is related to a pair of a transmit channel and a receive channel.

At least two transmit channels and at least two receive channels each correspond to a respective fan shaped beam. The fan shaped beam represents a region of a fan shaped radiation pattern associated with a microwave signal.

The fan shaped beams each have a first dimension and a second dimension which is perpendicular to the first dimension. The first dimension is significantly larger than the second dimension as it is at least three times larger than the second dimension. The first dimension relates to an elevation angle, whereas the second dimension relates to an azimuth angle. Thus, the electromagnetic energy associated with the fan shaped beam does not spread equally in all directions. The electromagnetic energy is directed mainly in a desired direction and attenuated in other directions.

The fan shaped beam corresponding to the receive channel—fan shaped receive beam—overlaps with the fan shaped beam corresponding to the transmit channel—fan shaped transmit beam—, thereby defining an overlap area. The transmit channel is associated with the fan shaped transmit beam having specific signal characteristics. A transmitted microwave associated with the fan shaped transmit beam is reflected by an object of interest in the sensor's surrounding space, thereby forming an echo wave that has an overlap with the fan shaped receive beam.

The echo wave has altered signal characteristics with respect to the transmitted microwave. The evaluation unit processes a receive signal based on the transmitted signal, providing a result signal having a radar result characteristic. The radar result characteristic may include amplitude, frequency, phase, etc. of the microwave signal. The radar result characteristic is assigned to the corresponding receive channel and each field of the image is assigned a result information based on a radar result characteristic provided by the receive channel.

The radar result characteristic assigned to a receive channel is due to a specific pair of overlapping transmit and receive beams forming an overlap area. Therefore, each field of the image relates to an overlap area of a transmit beam and a receive beam.

The invention is characterized in that the transmit channel correlates with the transmitter unit, which comprises a refractive beamformer. The refractive beamformer is an analogue passive beamformer and comprises a transmit reference plane to which the first dimension of the fan shaped beams of the transmit channels are perpendicular. The transmitter unit comprises a plurality of transmit transition structures associated with the refractive beamformer at different transition positions relative to the respective refractive beamformer. The transmit transition structures are located either preferably on the surface of the refractive beamformer or a short distance away. The transmit transition structures transform an electrical signal into an electromagnetic signal which is directed into the refractive beamformer of the transmitter unit. The microwave is refracted by the refractive beamformer, thereby generating transmit beams. Therefore, each transmit channel is related to at least one transmit transition structure.

The refractive beamformer changes the directionality of electromagnetic waves passing through it, thereby achieving spatial selectivity in the transmission of the microwave signal. Thus, on account of the refractive beamformer the energy radiated does not spread equally in all directions. Rather, it is directed in a desired direction and attenuated in other directions. Specifically, the electromagnetic waves are associated with the fan shaped beams of a fan shaped radiation pattern associated with a microwave signal. The fan shaped beam represents an angular region of the radiation pattern, where the angular region comprises gain values close to the maximum gain, typically less than a particular threshold value below the maximum gain. The threshold value is relative to the maximum gain amplitude of the radiation pattern and may, for example, range from a value of 3 dB to 10 dB.

The first dimension of the fan shaped transmit beam is perpendicular to the transmit reference plane. The first dimension of the transmit beam extends over a transmit elevation angle which lies in a transmit elevation plane that is perpendicular to the transmit reference plane. The second dimension extends over a transmit azimuth angle that lies within the transmit reference plane. In particular, the first dimension corresponds to a beam height and the second dimension corresponds to a beam width.

Furthermore, in analogy to the transmit channel, the receive channel correlates with the receiver unit which comprises a refractive beamformer, i.e. an analogue passive beamformer, which comprises a receive reference plane to which the first dimension of the fan shaped beams of the receive channels is perpendicular. The receiver unit comprises a plurality of receive transition structures associated with the refractive beamformer at different transition positions relative to the refractive beamformer, so that each receive channel is related to at least one receive transition structure.

Multiple receive transition structures at different transition positions are associated with the refractive beamformer of the receiver unit and are located either preferably on the surface of the refractive beamformer or a short distance away. Each receive transition structure is associated with an individual transition position relative to the refractive beamformer of the receiver unit. The receive transition structures receive the corresponding echo of the transmitted electromagnetic signals once these have passed through the refractive beamformer of the receiver unit. The echo waves enter the refractive beamformer and those echo waves which have a wave direction that correlates with a particular receive beam are assimilated efficiently by the corresponding receive transition structure. In other words, spatial selectivity in reception of the echo wave is achieved and the first dimension of a receive beam is perpendicular to the reference plane of the receiver unit, whereas the second dimension lies in the receive reference plane.

Analogously, the same definitions of elevation plane, elevation angle and azimuth angle are valid for the receiver unit. The first dimension of a receive beam extends over a receive elevation angle which lies in a receive elevation plane that is perpendicular to the receive reference plane. The second dimension extends over a receive azimuth angle that lies within the receive reference plane.

According to the invention, in order to generate the image of at least part of the space surrounding the microwave imaging radar sensor, an image area can be related to fields, where each field correlates to a set of a transmit channel and a receive channel, whose respective fan shaped beams overlap, thereby providing overlap areas which correlate with result information which is based on radar result characteristics. The result information is assigned to the individual fields of the image. Due to the embodiment of the transmitter unit and the receiver unit, the overlap areas have a fixed relation to paired positions of the respective transmit transition structures of the transmitter unit and the receive transition structures of the receiver unit. Therefore, the image, which is formed by a cumulation of overlap areas, is derived by a mere knowledge of an evaluated relation of transmit channel—receive channel.

On account of the embodiment of the transmitter unit and the receiver unit, the respective refractive beamformers, which are analogue passive beamformers, each have multiple transition structures associated with them, which can be addressed discretely one after the other to transmit microwaves. In other words, multiple transmit transition structures, each associated with an individual transition position relative to the respective refractive beamformer, can be discretely triggered one after the other, thereby implementing beam-switching in the transmitter unit. The addressed transmit transition structures are assigned to a specific transmit channel. For each discrete transmit channel a multitude of receive transition structures can provide receive signals from an echo wave. An evaluation of a receive signal is based on the corresponding transmit signals, thereby providing a result signal which has a radar result characteristic, which is assigned to a corresponding receive channel. In other words, the output of one transition channel, which preferably corresponds to a single transmit transition structure, correlates with the input of multiple receive transition structures corresponding to respective receive channels.

The transmit channel and the receive channel are evaluated set-wise. Therefore, a single evaluation cycle can establish a correlation between an individually addressed transmit transition structure and multiple receive transition structures being evaluated for the radar result characteristics from which result information is obtained. Hence, by evaluating a single transmit-receive channel relation, a plurality of fields of the image are assigned with the result information provided by the radar result characteristics. This represents a fast and easy analysis for generating an image of at least a part of the sensor's surrounding space.

In a preferred embodiment the evaluation unit comprises a radar control unit and an imaging unit being connected to each other, where the radar control unit is connected to the transmitter unit and the receiver unit by transmission lines, where the imaging unit comprises the output port. The radar control unit is connected to the transmit transition structures of the transmitter unit and to the receive transition structures of the receiver unit by transmission lines which are compatible for a connection with the radar control unit and transmit electrical signals between the radar control unit and the transition structures of the transmitter and receiver unit respectively.

Furthermore, the radar control unit is connected to the imaging unit, which allocates the result information pertaining to the radar result characteristics provided by the overlapping beams to the individual fields of the image, thereby creating an image of at least a part of the sensor's surrounding space. Each result information based on the respective radar result characteristic and hence each field of the image correlates with a predefined pair of a receive and transmit channel. The correlation of receive and transmit channels to the respective overlap areas is preferably defined in a table stored in a data memory of the imaging unit.

The image is then output by the imaging unit using the output port. For instance, it can be output to an image processing unit for further analysis on the image. The image processing unit can be part of the microwave imaging radar sensor or part of a sensor system containing the microwave imaging radar sensor.

The transmit and/or receive transition structure relays a signal between the transmission line and a waveguide, where the waveguide propagates electromagnetic energy associated with a microwave between the transmit and/or receive transition structure and the respective refractive beamformer. Specifically, the transmit transition structure receives electrical energy from the transmission line connecting it to the radar control unit. The transmit transition structure converts the electrical energy into electromagnetic energy, which is directed to the transmitter unit's refractive beamformer by a waveguide associated with the transmit transition structure. Thus, the refractive beamformer of the transmitter unit is fed with a microwave by the waveguide at a transition position associated with the respective transmit transition structure.

Conversely, electromagnetic energy received by the refractive beamformer of the receiver unit passes into the waveguide at a transition position and is directed from the refractive beamformer to the receive transition structure associated with the respective transition position. The receive transition structure converts the received electromagnetic energy to electrical energy, which is relayed to the radar control unit by the connecting transmission line.

The transmit and/or receive transition structure may for example be a tapered microstrip transition.

In a preferred embodiment the radar control unit sends a signal to a transmit transition structure or a combination of a plurality of transmit transition structures related to a specific transmit channel. The radar control unit addresses a specific transmit transition structure, triggering it to transmit a microwave, i.e. a specific transmit signal showing particular transmit characteristics. It is conceivable that the transmit transition structures are addressed individually one after the other or, alternatively, adjacent transmit transition structures are addressed simultaneously to generate a mixed microwave signal resulting in a beam having a main direction intermediate to the main direction of the beams of the two adjacent transmit transition structures. The transmit channel corresponds to an individually addressed transmit transition structure or a set of addressed transmit transition structures.

Further, the radar control unit receives a receive signal relevant to the corresponding echo wave by means of the receive transition structure, preferably multiple receive transition structures. The radar control unit determines the radar result characteristics for the receive signals based on the corresponding transmit signal. In other words, a plurality of receive transmit structures pick up receive signals related to an echo wave having different signal characteristics to the microwave. The radar control unit evaluates the echo, which is the receive signal, based on the corresponding transmit signal and thereby provides a result signal having a radar result characteristic, which is different to the transmit characteristic.

The radar control unit comprises an interface having an input port and an output port. The input port receives a specification of the transmit transition structures to be addressed and the transmit characteristics to be provided by the addressed transmit transition structures of the transmitter unit related to the transmit channel.

In reciprocity, the output port of the interface outputs a set of radar result characteristics related to the evaluated receive transition structures of the receiver unit related to the receive channel. The radar result characteristics per receive transition structure relates to a particular receive channel and can be fed to the imaging unit in a digital way.

According to a preferred embodiment, the sensor comprises a viewing direction to which a viewing plane is perpendicular, where the sensor comprises a sensor reference plane which is perpendicular to the viewing plane, and where the transmit reference plane and the receive reference plane are perpendicular are to the viewing plane. The viewing plane allows for a projection of at least a part of the sensor's surrounding space to be made by the imaging unit.

The sensor reference plane is perpendicular to the viewing plane, such that the sensor comprises a sensor elevation plane that is perpendicular to both the viewing plane and the sensor reference plane, where the sensor reference plane and the sensor elevation plane contain the viewing direction. The sensor reference plane thus contains a sensor azimuth angle and the sensor elevation plane contains a sensor elevation angle.

For providing the image in a preferred approach it can be assumed that the sensor reference plane, the transmit reference plane and the receive reference plane intersect in a common intersection line. This allows for an easy transfer of the transmit azimuth and elevation angles and the receive azimuth and elevation angles to the sensor azimuth and elevation angles, to which they correlate. This assumption is possible as the transmitter unit and the receiver unit, which each comprise a refractive beamformer preferably having a diameter of about 5 cm, are spaced apart by a short distance with respect to the intended measurement distance. More particularly, the transmit reference plane can lie within the sensor reference plane.

In a preferred embodiment the fan shaped beam comprises a main direction which is the direction of peak gain, where the main direction is dependent on the positioning of the transition structure relative to the respective refractive beamformer. The positioning and/or orientation of the transition structure relative to the respective refractive beamformer determines the main direction in which the electromagnetic signal associated with the fan shaped beam propagates. The main direction is the direction of peak gain in the second dimension which lies in the respective reference plane. In other words, the energy associated with the beam is radiated predominantly in one direction which is the main direction lying in the respective reference plane, whereas the electromagnetic energy is radiated marginally in other directions.

At least two fan shaped beams of both the transmitter unit and the receiver unit each comprise a main direction which is oriented broadly in the viewing direction, so that at least two fan shaped beams of both the transmitter unit and the receiver unit overlap each other at least partially in the overlap areas. The fan shaped beams may show an angular deviation ranging from 90° to −90° between their main direction in the respective reference plane and the viewing direction.

Further, the at least two fan shaped beams of both the transmitter unit and the receiver unit overlap each other at least partially at a distance of more than 10 times the wavelength or, alternatively, about two times the major extension of the refractive beamformer in viewing direction preferably to the respective transmit structures. This allows for precise monitoring of the area close to the sensor.

The overlap areas are defined by the range of the sensor azimuth angle and sensor elevation angle. On account of at least two corresponding beams overlapping each other, at least two overlap areas are provided, thereby enabling a 2D image of at least a part of space surrounding the sensor to be provided advantageously already within a single evaluation of paired transmit-receive channels.

As the overlap areas correlate with fields of the image, a set of overlap areas defines an image area. The set of overlap areas can preferably contain all overlap areas. Accordingly, the sensor provides an image that is based on a 2D raster based on the entire scope or spectrum of the sensor azimuth angles and the sensor elevation angles.

In a preferred embodiment the imaging unit is connected to the radar control unit's interface. The imaging unit sets the input of the radar control unit to address a specific combination of transmit channels. The imaging unit specifies the distinct transmit transition structures which are to be addressed by the radar control unit and it specifies the signal characteristic to be transmitted by the transmit transition structures. This information is relayed to the radar control unit via its input port.

Reciprocally, the imaging unit receives the set of radar result characteristics each associated with a receive transition structure relating to the evaluated receive channels. The radar control unit evaluates the receive signal of an echo wave with respect to the corresponding transmit signal, thereby providing a result signal having a radar result characteristic, which is related to a particular receive transition structure, which in turn is assigned to respective receive channel. This information, namely the radar result characteristic associated with the related receive transition structure, is relayed to the imaging unit via the radar control unit's interface output port.

The imaging unit receives the radar result characteristic related to the receive transition structure and processes the radar result characteristic to determine the result information. The imaging unit then creates the image by relating the fields, which each correspond to a pair of a transmit-receive channel, to the result information based on the radar result characteristics obtained. As the fields have a fixed relation to paired transmit-receive channels, the fields also relate to corresponding pairs of transmit and receive transition structures.

The image fields can be correlated with a subzone of at least a part of the sensor's surrounding space. The overlap area has a result information based on the radar result characteristic associated with it and is derived by a mere knowledge of an evaluated relation of transmit channel—receive channel, allowing a fast and easy analysis of at least a part of the sensor's surrounding space to generate an image of the detection zone, which is a subzone of the sensor's surrounding space.

According to one embodiment of the invention, the refractive beamformer is a dielectric lens. A dielectric lens comprises a solid dielectric material which particularly varies in its permittivity. The physical characteristic of the solid dielectric material affects the way the microwave is refracted, i.e. directed or propagated through the lens. The dielectric lens is designed to refract a wave in such a way that the radiation emitted is fan shaped, comprising fan shaped beams which are a region of the radiation pattern. The refraction steers the emitted energy by narrowing the beam width and thereby improving directivity in the second dimension, which corresponds to the azimuth angle of the beam with respect to the respective reference plane. On the one hand the transmit beam exhibits an enhanced fan shape and the directivity drives most of the energy into the main direction. On the other hand, the receiver unit has a fan shaped beam as well, so by using this combination a high spatial selectivity is achieved by preventing the undesired spreading of energy. This improves the efficiency of the sensor.

The echo wave reflected by an object of interest and having a specific direction is focused by the dielectric lens of the receiver unit. The echo waves are refracted by the dielectric lens such that they cross at a focal point of the lens. In particular, echo waves are focused at focal points at the respective antipodes of the lens. Here, the receive signals can potentially feed into the receive transition structures, depending on the exact position and/or orientation of the receive transition structures. Receive transition structures which preferably coincide with a focal point are able to take up energy from the reflected microwaves.

The variation in permittivity of the lens can, for instance, be obtained by radially adjoining several dielectric layers, each layer having a different dielectric permittivity, for instance different dielectric materials. It is also conceivable that a variation in permittivity is achieved by distributing air holes differently within the lens material. The distribution of holes may differ in terms of the density of holes in the lens, spacing between the holes, the diameter of the holes, etc.

According to a preferred embodiment the dielectric lens is a gradient index lens. Gradient index (GRIN) lenses exhibit a gradient of the refractive index of the lens material, i.e. the dielectric permittivity varies throughout the lens material in a gradient in the case of non-magnetic materials. The GRIN lens can preferably have a maximum index at its center and a minimum index at its periphery. In order to provide a fan shaped radiation pattern, a GRIN lens is cylindrical and has a refractive index which preferably decreases in the radial direction. The cylindrical gradient index lens preferably has an edge permittivity of more than 1.5, preferably more than 2.5, more preferably more than 3.0.

In one embodiment the cylindrical lens is a generalized Luneburg lens. A classical Luneburg lens is a well-known approach of beam shaping, with the lens having a variable index of refraction and one focal point on the lens surface or perimeter and the other focal point at infinity. The focusing properties of the lens can be achieved by an infinite number of different relationships between the distribution of the value of the dielectric permittivity inside the lens and the radius of the lens.

The cylindrical generalized Luneburg lens is a symmetric gradient index lens that has a focal point which is distributed on a focal-point-cylinder. The focal-point-cylinder preferably has a radius corresponding to the lens, i.e. the focal point lies on the periphery of the lens. However, it is also conceivable that the focal-point-cylinder may have a smaller radius than the cylindrical lens, where the focal point lies within the lens itself.

The cylindrical generalized Luneburg lens is able to transform a wave emitted from one of its focal points to a pseudo-planar wave, i.e. having a fan shaped pattern, at the opposite side of the lens, thereby transmitting a beam having a small angular width from an emerging area of the external surface of the cylindrical lens.

The rotational symmetry of the cylindrical generalized Luneburg lens enables the multiple transition structures associated with it to be oriented in widely different directions, which provides the microwave radar sensor with a wide angular range for directing beams and analysing at least a part of the space surrounding the sensor. This type of lens is appropriate for applications in which wide beam switching is needed along with a high antenna gain.

The reference plane of the cylindrical generalized Luneburg lens is perpendicular to the middle axis of the lens. This lens collimates electromagnetic radiation which enters the lens at the transmit transition structures. The lens concentrates the electromagnetic signal in a narrow beam in the second dimension, which lies within the reference plane and consequently perpendicular to the middle axis of the lens. Refraction by the cylindrical Luneburg lens results in the fan shape of the beam, thereby resulting in a highly directive radiation pattern with increased gain. This minimizes undesired spreading of the energy and improves the efficiency of the sensor.

An object in the space surrounding the sensor reflects a transmitted microwave. The microwave has a maximum signal which is mainly concentrated in one dimension and attenuated in the other dimension, allowing enhanced reception of the echo wave by the receiver unit and increasing the resolution of the sensor. Specific directions of echo microwaves are focussed on focal points of the lens by this embodiment of the generalized Luneburg lens. Multiple receive transition structures are located at the circumference of the lens close to such focal points. If their position coincides with a peripheral focal point on which echo waves are focussed, the receive transition structures pick up the signal. Particularly, the focal points are peripheral focal points and the receive transition structures are positioned covering the peripheral focal points.

In a preferred embodiment the cylindrical generalized Luneburg lens has a dielectric permittivity gradient which varies as a square law of the radial position. In particular, the relative permittivity Er at the centre of the lens is proportional to the root of the relative permittivity εᵣ at the peripheral edge of the lens. Preferably the relative permittivity εᵣ at the centre can be calculated by the relation below, allowing for a tolerance band of 0.2.

$${ε}_{r ( centre )} = 1.42 √ {ε}_{r ( peripheral edge )} + 0.58$$

The relative permittivity εᵣ may also follow the condition: |ε_{r(centre)}−ε_{r(peripheral edge)}|>0.1.

The distribution of permittivity is normalized by the relative permittivity εᵣ of the external medium in which the lens should radiate. A relative permittivity εᵣ of 1 refers to the external medium air. The relative permittivity εᵣ at the peripheral edge is not bound to be equal to 1. The distribution of relative permittivity εᵣ in the lens according to above relationship ensures optimal gain for the lens.

Preferably, the reference plane of the receiver unit and the reference plane of the transmitter unit intersect, where the intersection angle is between 0° and 90°; i.e. 0°≤intersection angle≤90°. The receiver unit and the transmitter unit each comprise a refractive beamformer. The refractive beamformer of the receiver unit is set inclined to the refractive beamformer of the transmitter unit, forming the intersection angle which is between 0° and 90°.

In particular, each transition structure correlates with a fan shaped radiation pattern having beams with a first dimension in the viewing plane being perpendicular to the respective reference plane. The microwaves emitted by the transmit transition structures may be reflected by objects in the space surrounding the sensor in such a way, that the corresponding radiation patterns of the transmitter and receiver unit overlap each other, thereby including the intersection angle between them. The overlap areas are related to subzones of the surrounding space. These overlap areas have a fixed relation to paired positions of the respective transition structures of the transmitter unit and the receiver unit. The position of the overlap area is determined relative to the sensor's reference plane depending on the angle between the transmitter unit reference plane and the receiver unit reference plane.

In a preferred embodiment the intersection angle of the transmit reference plane and the receive reference plane is between 15° and 90° so that a monitoring grid can be formed. The receiver unit is set such that the receive reference plane is inclined to the transmit reference plane of the transmitter unit at an angle between 15° and 90°. Consequently, the respective radiation patterns are inclined at the same respective angle to each other. This enables at least a part of the sensor's surrounding space to be depicted by a sort of grid resolution of the overlap areas of the corresponding fan shaped beams.

One embodiment provides that the radar control unit comprises a receiving chain that is connected to the receiver unit, so that the radar control unit determines the signal characteristics received via a plurality of receive transition structures and derives the radar result characteristics depending on the transmit signal. The radar result characteristics per receive transition structure can be fed to the imaging unit in a digital way. Specifically, the radar control unit's interface comprises an output port that provides a set of radar result characteristics each related to a corresponding receive transition structure which is associated with a receive channel.

Furthermore, the radar control unit comprises a transmission chain that is connected to the transmitter unit. The radar control unit relays information from the imaging unit to the transmitter unit. The information comprises a set of output signal characteristics related to a transmit transition structure, i.e. the information determines which of a plurality of transmit transition structures are to be addressed to provide the particular transmit characteristic. Thus, a transmit channel is related to a single transmit transition structure or a plurality of simultaneously addressed transmit transition structures, so as to generate a mixed signal.

In a preferred embodiment the radar control unit carries out at least one evaluation cycle in which a relation is established between the transmit channel and the set of receive channels. In each evaluation cycle the radar control unit addresses a single transmit transition structure or a combination of transmit transition structures to send a signal having a specific signal characteristic to a single transmit transition structure or a combination of transmit transition structures.

The radar control unit can execute a plurality of evaluation cycles. In each evaluation cycle the radar control unit addresses a predefined transmit channel. The evaluation cycles are triggered by the imaging unit, where the number of evaluation cycles depends on the number of relations defined in a data memory necessary to generate the intended image.

The imaging unit receives the radar result characteristics of the set of receive transition structures and relates it to the respective receive channels in each evaluation cycle. The imaging unit processes the radar result characteristics to determine the result information. The result information is related to a particular receive transition structure, thus the imaging unit can allocate the result information to a corresponding receive channel. The imaging unit then assigns the result information to the overlap area corresponding to the transmit-receive channel for each evaluation cycle.

Accordingly, multiple relations of one transmit channel and a plurality of receive channels are analysed and related to each other in a single evaluation cycle. Therefore, at least a part of the sensor's surrounding space can be scanned fast with a low effort on analysis, because the receive transition structures can be analysed simultaneously. The low effort is linked to the fact that an overlap area can be determined by simply using the predefined relation of transmit and receive channels.

Within the repetition of evaluation cycles, the transmit channels which correspond to a discrete addressed transmit transition structure or sets thereof, are analysed sequentially one after the other, i.e. each single transmit channel is related preferably to several receive transition structures each assigned to a receive channel. It is conceivable that the radar control unit is able to process in parallel the receive signals obtained by the receive transition structures. Consequently, in such a case and in order to ensure fast analysis, it is preferable for the receiver unit to have more transition structures than the transmitter unit, as this allows for the analysis of fewer sets of transmit channels per cycle, which can reduce the evaluation time per cycle substantially.

Repetition of the evaluation cycles enables the imaging unit to generate an image from the data set comprising the addressed transmit transition structures corresponding to the receive transition structures and the result information based on the radar result characteristics obtained therefrom, where the result information is assigned to individual fields of the image. The image can be a set of raw data. In particular, the image can be an array of values related to the result information, from which a graphic image can be created, for example.

The imaging unit can then output the image.

Preferably the imaging unit comprises a data memory which stores a mapping information, consisting of a plurality of relations between the transmit channels and the receive channels and the overlap area, particularly overlap area coordinates.

More preferably the data memory may comprise a plurality of mapping information each related to a specific angle between the transmit reference plane and the receive reference plane. Accordingly, the resolution of at least a part of the space surrounding the sensor can be flexibly adjusted to certain conditions during operation.

The imaging unit uses the mapping information in the data memory to assign the result information generated in each evaluation cycle by the radar control unit to the corresponding overlap area.

The imaging unit analyses the radar result characteristics to determine result information, for example by evaluating a signal based on the Doppler effect, amplitude or distance. For example, if the result information includes “distance”, an image processing unit may be able to provide a 3D image by knowing the overlap area.

In a preferred embodiment the imaging unit outputs the image being a raw data image, for instance an array having multiple entries related to the result information per single overlap area, to an image processing unit which maps the image of at least a part of the sensor's surrounding space as a grid consisting of a plurality of pixels which are stored in the data memory, where each pixel is assigned to a relation between the transmit transition structure and the receive transmission structure. Each image field is gridded into multiple pixels. Each pixel relates to a section and/or a position of at least a part of the surrounding space. Each pixel is assigned a value related to the result information. Accordingly, the processed image can be a graphic image. The value and/or changes in values relating to the result information may be coded, e. g. colour-coded, enabling a pixel image to be created by using graphic image processing and/or filter algorithms. Hence, the image processing unit can create a visually processed image of at least a part of the space surrounding the sensor from the grid.

In a preferred embodiment the transmit signal and the radar result characteristic are generated by FMCW. The radar control unit operates in a FMCW-mode. Frequency modulated continuous wave radar emits a continuous transmit signal whose frequency is continuously varied at a known rate, i.e. the working frequency is altered during measurement. Commonly this may comprise a linear change of frequency over time. Modulation of the transmitted frequency enables additional measurements such as range and radial velocity of an object. By using this technique, the result information “distance” can be acquired.

Alternatively, the transmit and receive signals can be transmitted and received respectively in pulsed mode to determine the distance of the object of interest.

The radar result characteristics can also be analysed by evaluating the receive signal with respect to the transmit signal using the Doppler-effect in a continuous wave (CW) mode. The Doppler effect approach is a powerful tool used to analyse motion, i.e. velocity, of an object of interest in a microwave field. Microwave signals bounce off the object and the receive signal, i.e. returning frequency of the echo wave, is analysed to see how it has changed from the original transmit signal of the microwave. By observing the frequency shifts of scattered waves, data is produced about an object's velocity while its range/position remains unknown.

In a preferred embodiment the transmit transition structures are switched to accomplish beam switching, where a transmit signal is applied to one transmit transition structure at a time for each evaluation cycle. For each evaluation cycle a discrete transmit transition structure is addressed to radiate a transmit signal, i.e. the single distinct transmit transition structure is opened, allowing the transmit signal to radiate from the transmit transition structure to the refractive beamformer, whilst keeping the remaining transmit transition structures closed. Beam steering is embodied by switching amongst the transmit transition structures. In other words, by controlling the transmit transition structures the angular deviation of the main direction of the emitted electromagnetic radiation and the viewing direction is altered, the angular azimuth deviation being in the reference plane. In each successive evaluation cycle a different discrete transmit transition structure is opened to transmit the transmit signal. The transmit transition structures are triggered one after another in successive evaluation cycles, allowing the signal to sweep in the azimuth scope or spectrum, which is perpendicular to the first dimension. Beam switching results in a multitude of overlap areas. The overlap areas can be projected on the viewing plane, which is a projection of at least a part of the sensor's surrounding space. It is conceivable, that the overlap areas of the corresponding beams represent corridors in a cartesian coordinate system of at least a part of the sensor's surrounding space, such that a 3D spatial assignment may be made to the overlap areas, for instance by the image processing unit.

An alternate embodiment provides that for a transmit channel two adjacent transmit transition structures can be fed at the same time in a single evaluation cycle. In this case the radar control unit may execute a phase evaluation of the transmit transition structures to potentially correct a phase difference between the adjacent transmit transition structures.

According to a preferred embodiment the receiver unit, the transmitter unit and the transmission lines connecting the radar control unit to both the transmitter unit and the receiver unit are be implemented as a single circuit board, preferably comprising a PCB-body. Therefore, both the receiver unit and the transmitter unit are be embodied in the same PCB-body, which also comprises the transmission lines connecting the radar control unit with the transmitter unit and the receiver unit respectively. Transmission lines refer to a pair of wires or conductors that move energy from one point to another. They are structures that usually can be made of traces of copper and carry electrical signals through the PCB-body.

Preferably the single circuit board, in particular the PCB-body, comprises one core layer having at least one metallized layer at the top and at the bottom. The PCB-body can alternatively comprise multiple core layers where a top and a bottom metalized layer confine the PCB-body to provide the lens properties.

In particular, the PCB-body may comprise at least two cores, where the cores are attached to each other by at least one prepreg layer.

The PCB-body is made in a way that the transmitter unit can be inclined relative to the receiver unit. In particular, this can be achieved by using at least one flexible PCB core layer. This is known from SEMI-FLEX multilayer PCB-bodies, for example, and enables the transmitter unit and the receiver unit to be inclined relative to each other.

Furthermore, rigid core layers can be used additionally or alternatively, where a connecting region between two rigid regions that each have multiple layers may for instance, comprise only a single core layer resulting in a thinner area, thereby providing a flexible bending section.

By using at least two cores in the single circuit board, the transmit and/or receive transition structure can be embodied as a blind via.

According to a preferred embodiment, the at least one core layer is made of a dielectric substrate, where the core layer of the transmitter unit and the receiver unit forms the respective refractive beamformer having a curved contour. Dielectric substances are weak in electrical conduction, thus providing a non-conductive substrate layer between the conducting metal layers. The permittivity of the PCB substrate material has a significant influence on signal integrity and power integrity. Hence, the relative permittivity is preferably larger than 2.5, more preferably larger than 3.0. The relative permittivity in a very preferable way is around 3.5.

The respective refractive beamformer may, for example, form at least part of a cylinder. It may have a circular or elliptical contour in order to focus or expend a signal in the shape of a line, i.e. a fan-shaped beam, as opposed to a point or a circle. Thus, the dielectric core substrate and the possibly existing prepreg layer work as a lens, particularly a gradient index lens, where the dielectric index is influenced by holes through the dielectric layers of the core and the possibly existing prepreg layer, and where the metallized layers confine the core.

Preferably the waveguides are integral to the single circuit board and are confined by the metallized layer at the top and at the bottom of the PCB-body and also by the metallized vias connecting the metallized layers, thereby acting as side walls of the waveguide. The waveguide is made of the same substrate as the PCB-body. It is enclosed by the top and bottom metallized layer. These layers are connected to each other by metallized vias which traverse the PCB-body, thereby forming walls on either side of the waveguide. Thus, the waveguide encompasses an arrangement that acts as a physical constraint and is able to guide a wave in a particular direction by internal reflection. This reduces the loss of energy associated with the waves.

In a preferred embodiment the radar control unit is attached to the single circuit board and is connected to the transmit and receive transition structures. The radar control unit can be embodied as a microchip or a plurality of microchips which are attached to the PCB-body. The radar control unit is connected to the transmit transition structures of the transmitter unit and to the receive transition structures of the receiver unit by transmission lines which are compatible for a connection with the radar control unit, transmitting electrical signals between the radar control unit and the respective transmission lines.

Preferably the radar control unit can comprise a radar control receiving unit and a radar control transmitting unit, where each unit is embodied as a microchip that can be placed in vicinity to the corresponding refractive beamformer. Both microchips are interconnected to communicate a signal for synchronization. This allows to minimize or to reduce the length of the transition structures and the associated losses and still allows a radar evaluation at high frequencies.

The radar control unit is also connected to an imaging unit which may be on a separate PCB-body. Alternatively, the imaging unit can be attached to the same PCB-body to which the radar control unit is attached.

In a preferred embodiment the refractive beamformer is covered by a lens housing to provide radiation of circular polarization. The permittivity variation following the Luneburg law transforms a spherical electromagnetic wave emitted from the transition structures arranged around the circumference of the cylindrical lens into an almost plane wave at the lens output. This results in collimated beams which spread predominantly in the main direction and minimally in other directions as the energy propagates. Beams having a small angular width are emitted from an emerging area in the external surface of the cylindrical lens. The housing can convert the linear polarization of the electromagnetic radiation output by the lens into circular polarization. Circular polarization is preferred when analysing RF waves echoing from irregular objects as it can collect more reflected energy. As especially human bodies do not always maintain a linear polarization when the echo wave is reflected, the detection sensitivity of the microwave radar sensor can thus be increased.

Preferably the refractive beamformer is a cylindrical lens, where the lens is enclosed in a torus-like lens housing having a first dielectric property and having an open surface or a different dielectric material around its central axis of rotation at its opposing poles. The housing is shaped like a toroid having a central hyperboloid removed from it, such that opposing poles of the housing are open surfaces. Thus, the cylindrical lens is radially enclosed by the torus-like housing, whereas both flat circular surfaces of the cylindrical lens are only partially enclosed by the housing around the edges. By virtue of its curvature and its dielectric property, the toroid-like housing conveniently enhances the projection of a beam in one dimension, thereby further reducing undesired spreading of the beam's energy and improving the efficiency of the sensor.

In one embodiment the lens housing is integrated in a housing of the sensor. The entire microwave radar sensor, especially its electronic components, can be enclosed and be protected by a housing. The lens housing can be integrated in the sensor housing, enabling easy assembly of the sensor. It is conceivable that the integral housing comprising the lens housing and a part of the remaining housing may be produced as a single piece having the same material, such that the dielectric property is the same throughout the housing. Alternately, it is possible that a part interconnecting the sensor housing with the lens housing has a different dielectric property than the lens housing, which further enhances the directivity of the beams.

In a preferred embodiment, the microwave sensor comprises a plurality of transmitter units and a plurality of receiver units. This increases the resolution of the sensor. Alternatively, some transmitter and/or receiver units may act as back-up components to ensure redundancy if primary components should fail.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. In the drawings is shown

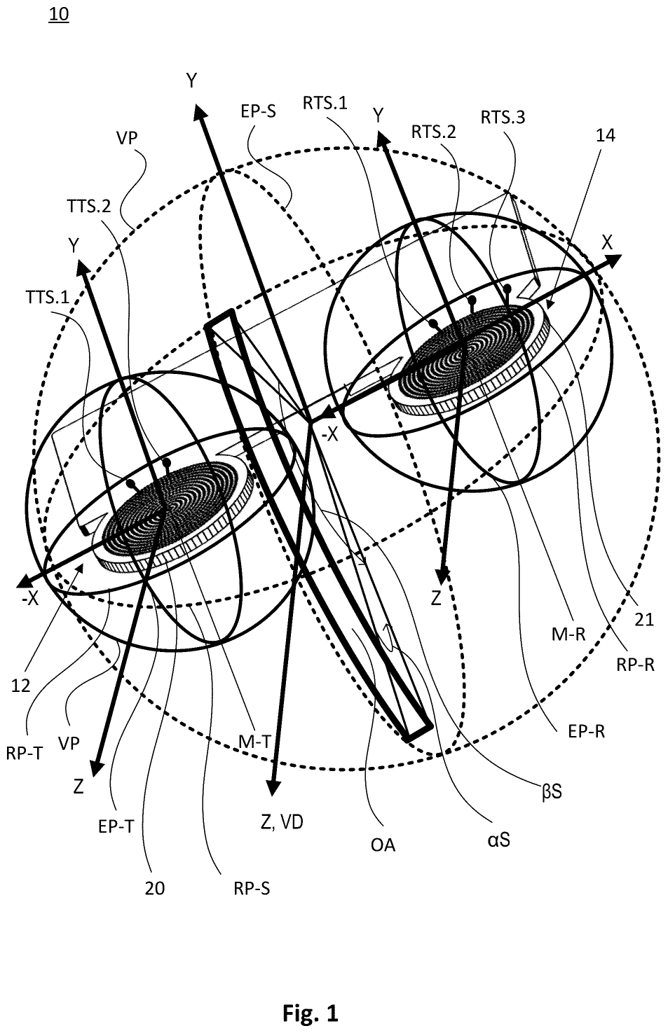

FIG. 1 a perspective view of a first embodiment of a microwave imaging radar sensor;

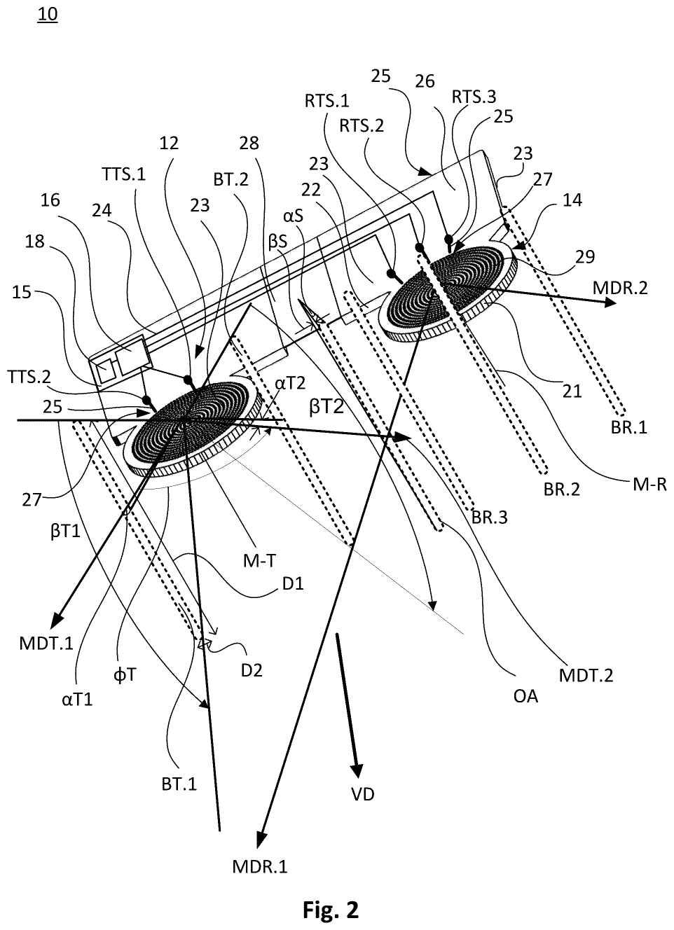

FIG. 2 a microwave imaging radar sensor with transmitted and receive beams according to FIG. 1;

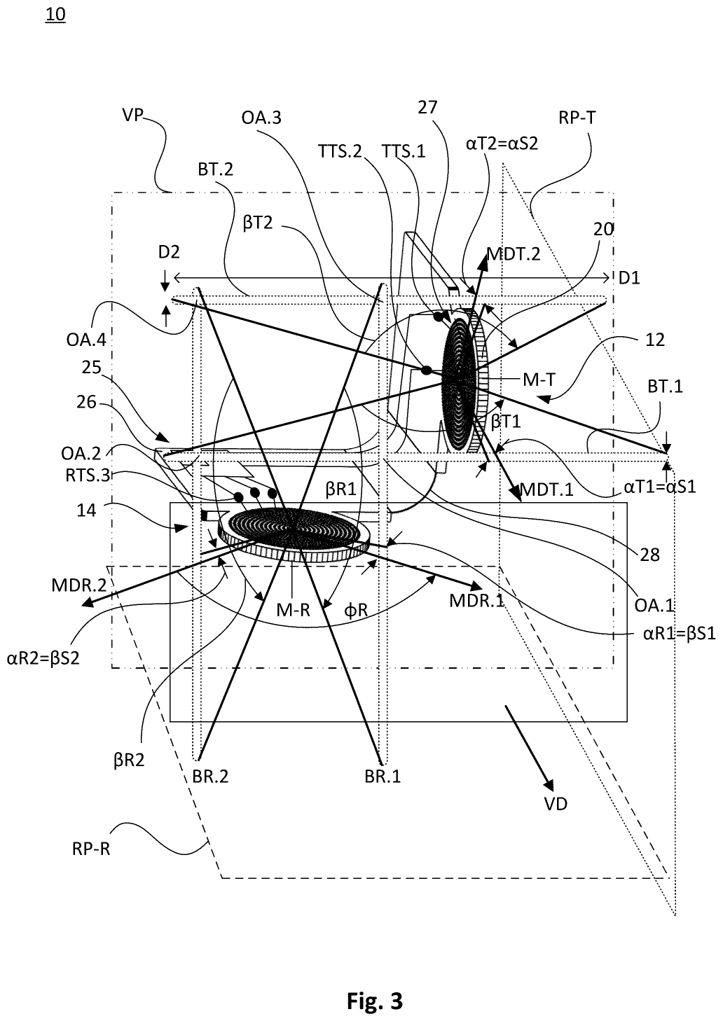

FIG. 3 a perspective view of a second embodiment of a microwave imaging radar sensor;

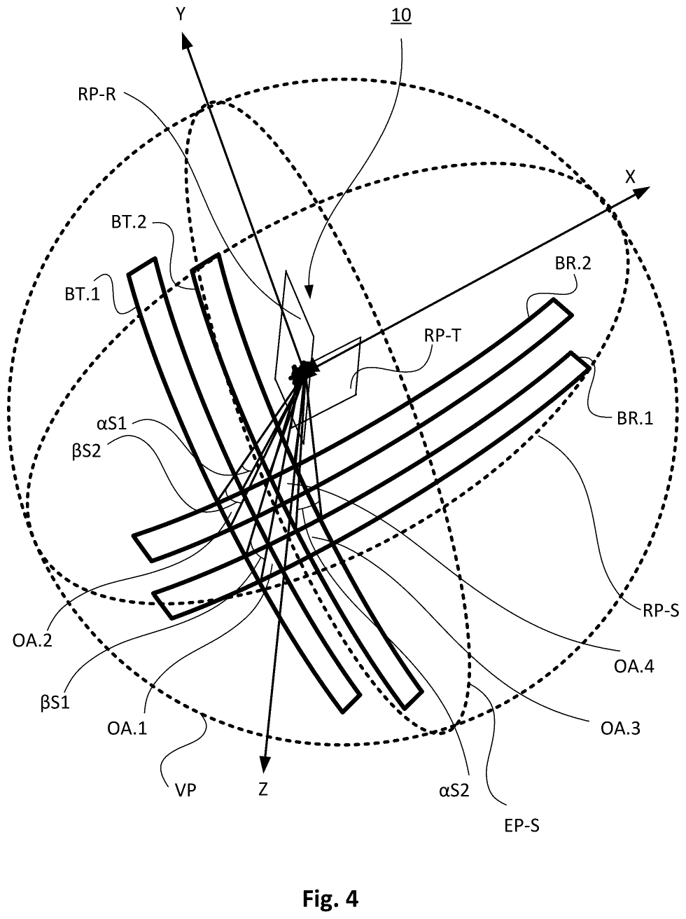

FIG. 4 a microwave imaging radar sensor according to FIG. 3 in a far field representation;

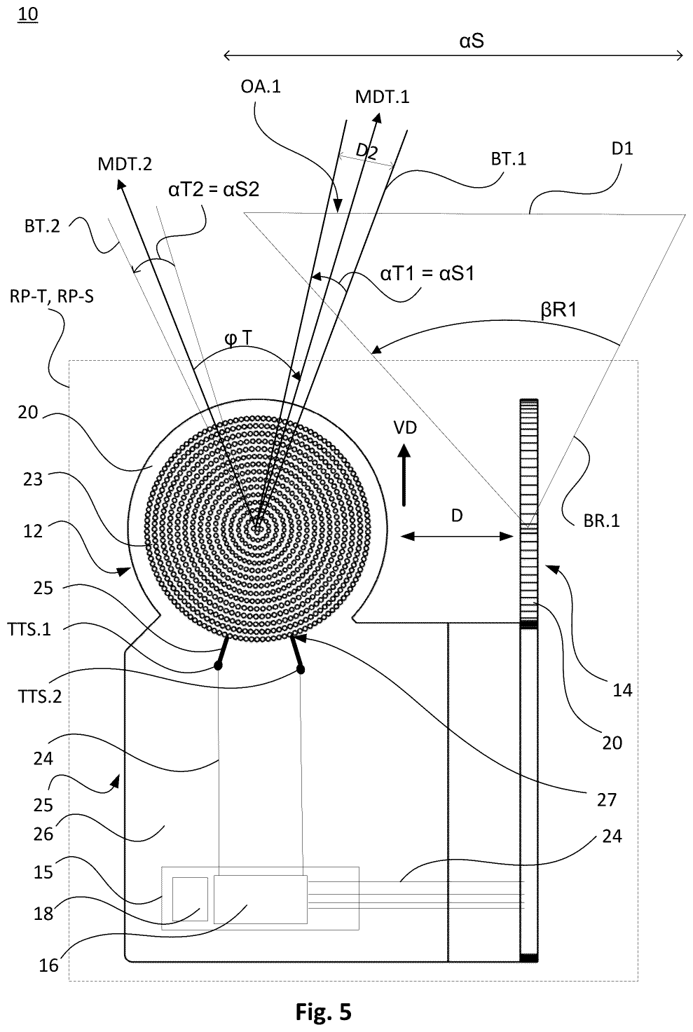

FIG. 5 a top view of the microwave imaging radar sensor according to the second embodiment in FIG. 3;

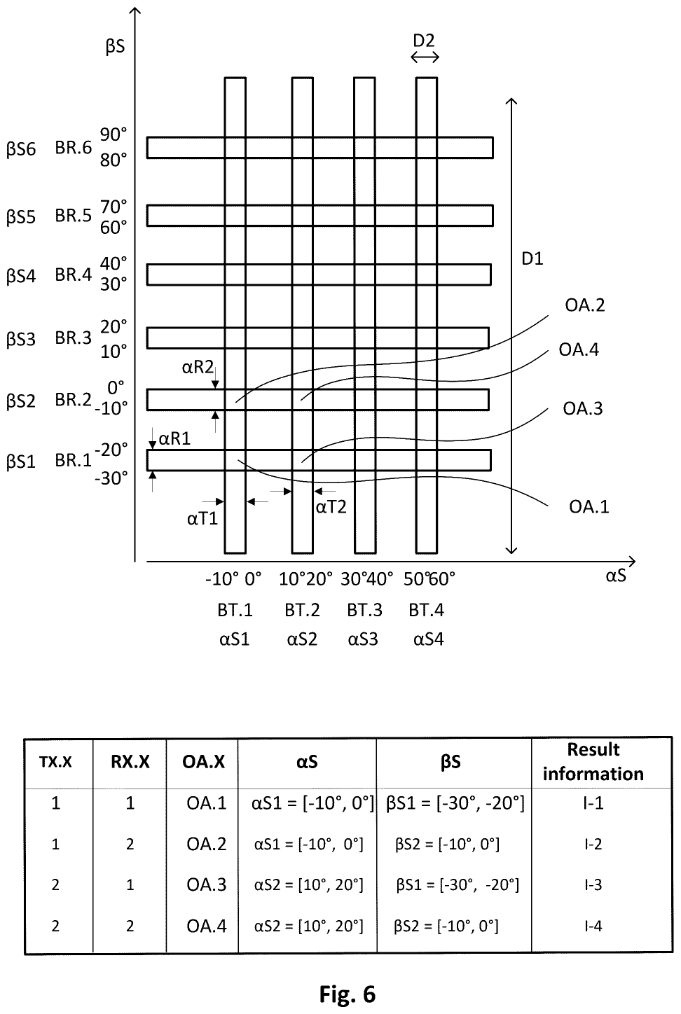

FIG. 6 a grid of overlap areas provided by corresponding fan shaped transmit and receive beams;

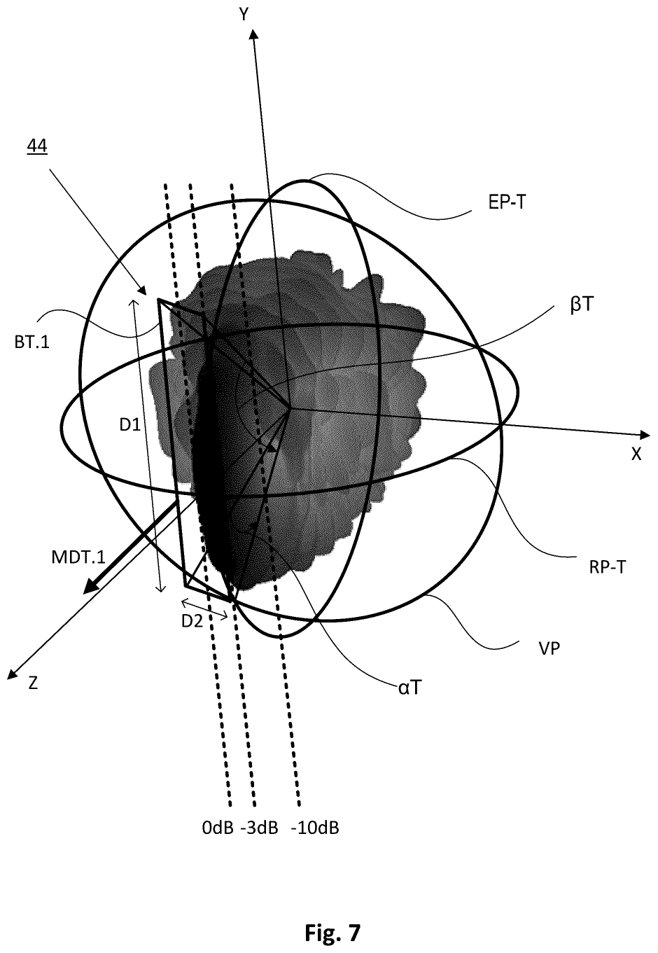

FIG. 7 a fan shaped radiation pattern comprising a fan shaped beam;

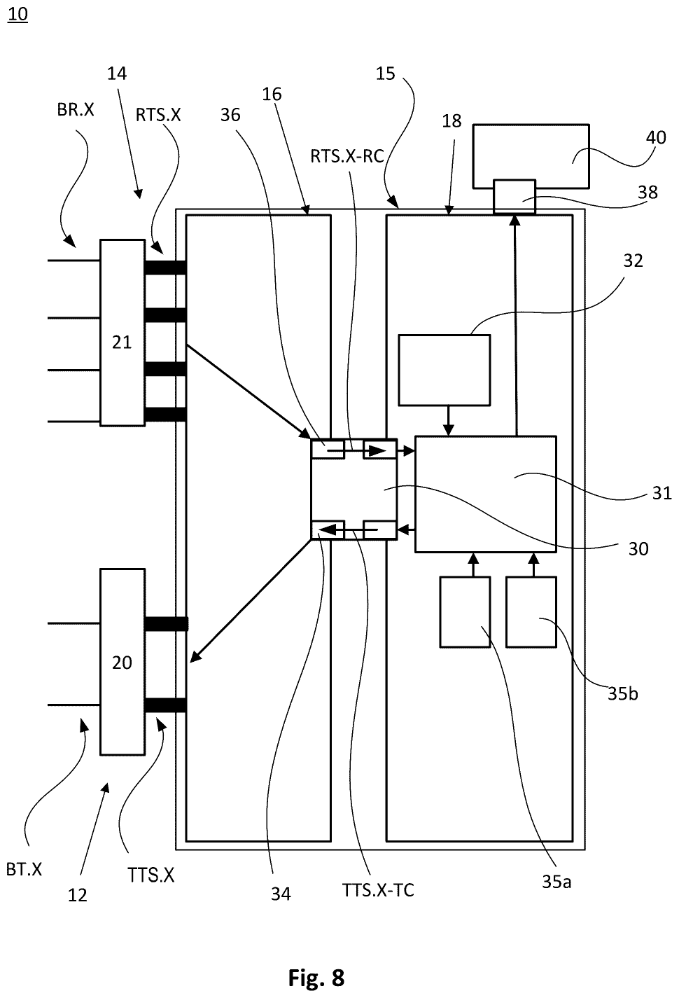

FIG. 8 a summary of the microwave imaging radar sensor generating an image of at least a part of its surrounding space, and

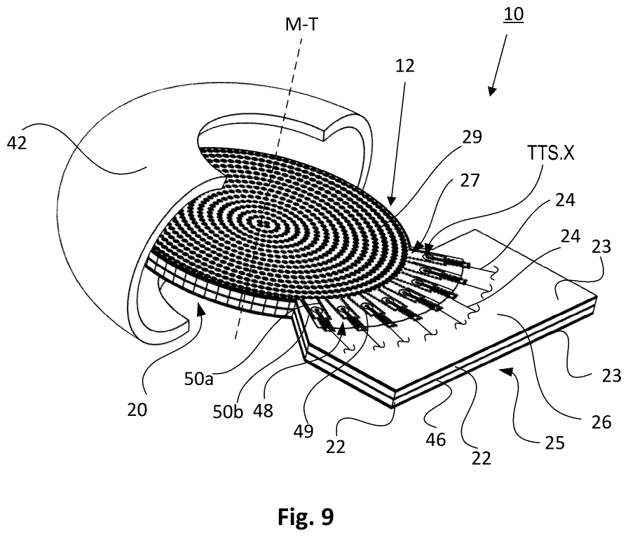

FIG. 9 a microwave imaging radar sensor comprising a housing for the refractive beamformer.

FIG. 1 shows a perspective view of a first embodiment of a microwave imaging radar sensor 10 according to the invention. The microwave imaging radar sensor 10 comprises a transmitter unit 12 and a receiver unit 14, which are connected to an evaluation unit 15, which is not shown in FIG. 1 for the sake of clarity. A respective coordinate system X, Y, Z is allocated to the sensor 10, the transmitter unit 12 and the receiver unit 14.

The sensor 10 comprises a viewing direction VD which is directed towards its surrounding space and a viewing plane VP which is perpendicular to the viewing direction VD. The sensor 10 has a sensor reference plane RP-S in the plane X-Z, and a sensor elevation plane EP-S in the Y-Z plane. As a consequence, the sensor reference plane RP-S is perpendicular to the sensor elevation plane EP-S.

The transmitter unit 12 comprises a refractive beamformer 20 with a middle axis M-T. The transmitter unit 12 also comprises a transmit reference plane RP-T, where the centre of the coordinates X, Y, Z for the transmitter unit 12 lies in the intersection of the middle axis M-T, the transmitter reference plane RP-T and the viewing plane VP. The transmit reference plane RP-T lies in the X-Z plane of the transmitter unit 12 and is perpendicular to the viewing plane VP lying in the X-Y plane. The transmitter unit 12 has a transmit elevation plane EP-T, which lies in the Y-Z plane and is perpendicular to both the transmit reference plane RP-T and the viewing plane VP.

The receiver unit 14 comprises a refractive beamformer 21 with a middle axis M-R. The receiver unit 14 also comprises a receive reference plane RP-R. The centre of the coordinates for the receiver unit 14 lies in the intersection of the middle axis M-R, the receive reference plane RP-R and the viewing plane VP. The receiver unit 14 comprises a receive reference plane RP-R which lies in the sensor's X-Z plane and is perpendicular to the viewing plane VP lying in the plane X-Y. The receiver unit 14 comprises a receive elevation plane EP-R which is in the plane Y-Z and is perpendicular to both the receive reference plane RP-R and the viewing plane VP.

In the present embodiment the transmitter unit 12 and the receiver unit 14 lie in the same plane X-Z, thus the transmit reference plane RP-T and the receive reference plane RP-R intersect at an angle=0°. The transmit reference plane RP-T and the receive reference plane RP-R are both parallel to the sensor reference plane RP-S and may particularly coincide with it. The sensor elevation plane EP-S is parallel to the transmit elevation plane EP-T and the receive elevation plane EP-R and lies at half the distance between the transmit middle axis M-T and the receive middle axis M-R.

The transmitter unit 12 and the receiver unit 14 each comprise a respective refractive beamformer 20, 21 which is made of a dielectric material and changes the directionality of microwaves passing through them.

A plurality of transmit transition structures TTS.X, in particular two transmit transition structures TTS.1, TTS.2, are associated with the refractive beamformer 20 of the transmitter unit 12 and a plurality of receive transition structures RTS.X, in particular three receive transition structures RTS.1, RTS.2, RTS.3, are associated with the refractive beamformer 21 of the receiver unit 14. The respective transition structures TTS.1, TTS.2, RTS.1, RTS.2, RTS.3 are positioned at different transition positions 27 around the respective circumferences of the transmitter unit 12 and the receiver unit 14.

In the first embodiment shown in FIG. 1, the refractive beamformer 20 has two transmit transition structures TTS.1, TTS.2 arranged around its periphery. They convert electrical energy into electromagnetic energy, which then travels into the refractive beamformer 20, whereas three receive transition structure RTS.1, RTS.2, RTS.3 are associated with the refractive beamformer 21 of the receiver unit 14 to receive echo waves.

According to the embodiment shown, the refractive beamformers 20, 21 are cylindrical in shape, thus providing fan shaped radiation patterns, as described in FIG. 7.

Microwaves transmitted by the transmitter unit 12 and having specific signal characteristics are reflected by an object in the space surrounding the sensor. The addressed transmit transition structure TTS. 1, TTS.2 which transmits a microwave signal is assigned to a transmit channel.

An echo wave having altered characteristics can be received by the receiver unit 14 at a plurality of receive transition structures RTS.1, RTS.2, RTS.3. The signals of the echo wave are then compared to the transmitted signal, thereby providing result signals having a radar result characteristic. Each echo or receive signal is also evaluated with respect to the set of receive transition structures receiving the signals. Each result signal with its specific radar result characteristic is assigned to a receive channel depending on the receive transition structure RTS.1, RTS.2, RTS.3 or a combination of receive transition structures RTS.1, RTS.2, RTS.3 which received the respective echo or receive signals. Result information relevant to the radar result characteristic is allocated to a particular receive channel which is associated with a corresponding transmit channel.

A receive beam BR.X can overlap with a transmit beam BT.X thereby generating an overlap area OA. The overlap area OA corresponds to a sensor azimuth range αS and a sensor elevation range βS. The overlap area OA can then be correlated with spatial coordinates of a part of the sensor's surrounding space as well as a paired transmit-receive channel, and hence a radar result characteristic allocated to the receive channel.

Therefore, the overlap area OA corresponds to a paired transmit-receive channel, which in turn has a radar result characteristic assigned to it. An image can be created by allocating the result information derived from the radar result characteristic allocated to a paired transmit-receive channel to the overlap area. Thus, a spatial relation can be obtained from a mere knowledge of the paired sets of addressed transmit and receive transition structures and the radar result characteristic.

A set of overlap areas OA.X preferably contains all overlap areas OA.X. Accordingly, the sensor 10 provides an image that is based on a 2D raster based on the sensor azimuth range αS and the sensor elevation range βS and the radar result characteristics.

FIG. 2 depicts the microwave imaging radar sensor 10 according to the first embodiment shown in FIG. 1. The sensor 10 comprises a viewing direction VD.

The evaluation unit 15 of the sensor 10 comprises a radar control unit 16 and an imaging unit 18 which are connected to each other. The radar control unit 16 is connected to the transmitter unit 12 and the receiver unit 14 by transmission lines 24 which are compatible for a connection with the radar control unit 16.

In the present embodiment the transmitter unit 12, the receiver unit 14 and transmission lines 24 are embodied as a single circuit board 25, namely a PCB-body 26. The radar control unit 16 can be embodied as a microchip or a plurality of microchips, being attached to the PCB-body 26. The radar control unit 16 and the imaging unit 18 are attached to the same PCB-body 26. It is also conceivable that the radar control unit 16 and the imaging unit 18 are attached to separate PCB-bodies.

The circuit board 25 comprises a core layer 22 having a metallized layer 23 at the top and at the bottom confining the substrate of the of the core layer 22. In particular, the circuit board 25 comprises a PCB-body 26 with a flexible core 22, such that a connecting region 28 may comprise a thinner area, thereby providing a flexible bending section, thus enabling the transmitter unit 12 and the receiver unit 14 to be inclined relative to each other, as shown in the embodiments in FIG. 3 and FIG. 5. For instance, the PCB-body 26 may comprise two core layers 22, attached to each other by a prepreg layer, where the connecting region 28 may comprise only a single core layer 22 resulting in a thinner area, which allows for bending.

In FIG. 2 the at least one core layer 22 of the transmitter unit 12 and the receiver unit 14 forms the refractive beamformers 20, 21 respectively. The core layer 22, which is confined by metallized layers 23, is preferably made of a dielectric substrate and has a curved contour, thereby working as a lens, particularly as a gradient index lens. The dielectric index is influenced by holes 29 through the dielectric layers of the core 22. Thus, in the present embodiment, the refractive beamformers 20, 21 comprise dielectric bodies that are cylindrical, i.e. they have a circular contour and their respective circular top and bottom surfaces are each confined by a layer of metal. It is also conceivable that the refractive beamformers 20, 21 have an elliptical contour.

The refractive beamformers 20, 21 respectively have a plurality of transmit transition structures TTS.1, TTS.2 and receive transition structures RTS.1, RTS.2, RTS.3 associated with them. The transmit and/or receive transition structures TTS.1, TTS.2, RTS.1, RTS.2, RTS.3 may, for example, be tapered microstrip transitions and are located around the circumferences of the respective refractive beamformers 20, 21 either on the surface of the respective refractive beamformer 20, 21 or a short distance away. Each transition structure TTS.1, TTS.2, RTS.1, RTS.2, RTS.3 is associated with a respective transition position 27 relative to the respective refractive beamformer 20, 21.

The transition structures TTS.1, TTS.2, RTS.1, RTS.2, RTS.3 convert one form of energy into another, thereby transmitting signals between the transmission lines 24, which convey electrical energy, and the respective waveguides 48 associated with them, which guide electromagnetic energy in a certain direction. The waveguide 48 is made of the same core substrate as the PCB-body 26, where the core layer 22 is enclosed by a top and bottom metallized layer 23. The top and the bottom metallized layers 23 are connected with each other by metallized vias which traverse the core layer 22 and act as walls on either side of the waveguide 48. Thus, by internal reflection the waveguide 48 directs microwaves in a particular direction, namely between the refractive beamformers 20, 21 and the respective transition structures TTS.1, TTS.2, RTS.1, RTS.2, RTS.3.

Specifically, the radar control unit 16 supplies electrical energy and signals to the transmit transition structure TTS.1, TTS.2 via the connecting transmission line 24. The transmit transition structure TTS.1, TTS.2 converts the electrical energy into electromagnetic energy, i.e. a microwave. The microwave is guided by the waveguide 48, directing it to the refractive beamformer 20 at the respective transition position 27.

By reciprocity, electromagnetic energy received by the refractive beamformer 21 of the receiver unit 14 enters the waveguide 48 at a transition position 27 associated with a respective receive transition structure RTS.1, RTS.2, RTS.3. The waveguide 48 guides the electromagnetic energy, directing it to the respective receive transition structure RTS.1, RTS.2, RTS.3, which then converts the electromagnetic energy into electrical energy. The electrical energy and the signal associated with it are conveyed to the radar control unit 16 by the transition line 24.

Depending on the transition position 27 with which the transmit transition structure TTS.1, TTS.2 is associated, the refractive beamformer 20 refracts the transmitted microwaves and thus generates fan shaped beams BT.1, BT.2 which are represented schematically in FIG. 2. The transmit beams BT.1, BT.2 are defined by a transmit azimuth angular range αT and a transmit elevation angular range βT. The transmit azimuth angles αT1, αT2 lie within the transmit reference plane RP-T and the transmit elevation angles βT1, βT2 lie within the transmit elevation plane EP-T. The respective planes are shown in FIG. 1.

The transmit beams BT.1, BT.2 have a first dimension D1 over a transmit elevation angular range βT of particularly 60°. The first dimension D1 is perpendicular to the transmit reference plane RP-T. The transmit beams BT.1, BT.2 have a second dimension D2 perpendicular to the first dimension D1 over a transmit azimuth angular range αT of particularly 10°. Accordingly, the second dimension D2 is significantly smaller than the first dimension D1, which is at least three times larger than the second dimension D2. The first dimension D1 relates to an elevation angle βT1, βT2, whereas the second dimension relates to an azimuth angle αT1, αT2.

Depending on the transition positions 27 with which the transmit transition structure TTS.1, TTS.2 are associated, the beams BT.1, BT.2 have main directions MDT.1, MDT.2. In the example shown, the main directions MDT.1, MDT.2 of the transmit beams BT.1, BT.2 are spaced apart by an azimuth angle φT of about 120°.

Analogously, the same is valid for the receiver unit 14 except that the refractive beamformer 21 of the receiver unit 14 is associated with receive transition structures RTS.1, RTS.2, RTS.3 so that the receiver unit 14 can provide three fan shaped beams BR.1, BR.2, BR.3.

By way of the particular example shown in FIG. 2, the main directions MDR.1, MDT.2 of corresponding beams BR.1, BT.2 intersect and accordingly an overlap area OA of the second transmit beam BT.2 and the first receive beam BR.1 is obtained. Thus, the transmitted microwave is reflected by on object at this position so that a receive signal related to the echo wave is received by the receive transition structure RTS.1.

The overlap area OA corresponds to the sensor elevation range βS and the sensor azimuth range αS as shown in FIG. 2 and also described in FIG. 1.

FIG. 3 shows a perspective view of a second embodiment of the microwave imaging radar sensor 10, where in contrast to the first embodiment, the transmitter unit 12 and the receiver unit 14 are arranged orthogonally to each other, as the circuit board 25 exhibits a bend in a central connecting region 28. The transmit reference plane RP-T defined by the transmitter unit 12 and the receive reference plane RP-R defined by the receiver unit 14 include an intersection angle, which can preferably range from 15° to 90°. In the second embodiment the intersection angle corresponds to 90°.

The viewing plane VP is orthogonal to both the receive reference plane RP-R and the transmit reference plane RP-T. The viewing direction VD is orthogonal to the viewing plane VP and lies in the receive reference plane RP-R and the transmit reference plane RP-T.

The centre of the coordinates X, Y, Z (not shown) for the transmitter unit 12 lies in the intersection of the middle axis M-T, the transmitter reference plane RP-T and the viewing plane VP. The transmitter unit 12 has a transmit elevation plane EP-T which is perpendicular to the transmit reference plane RP-T and to the viewing plane VP.

Analogously, the centre of the coordinates X, Y, Z (not shown) for the receiver unit 14 lies in the intersection of the middle axis M-R, the receive reference plane RP-T and the viewing plane VP. The receiver unit 14 has a receive elevation plane EP-R which is perpendicular to the receive reference plane RP-R and to the viewing plane VP.

Thus, in the example shown, the transmit elevation plane EP-T correlates with the receive reference plane RP-R, and the receive elevation plane EP-R correlates with the transition reference plane RP-T.

The sensor 10 has a sensor reference plane RP-S parallel to the transmit reference plane RP-T and a sensor elevation plane EP-S perpendicular to the sensor reference plane RP-S and to the viewing plane VP.

Depending on the transition position 27 with which the transmit transition structures TTS.1, TTS.2 are associated, the refractive beamformer 20 shapes the electromagnetic energy into fan shaped beams BT.1, BT.2 which are represented schematically in FIG. 3. The transmit beams BT.1, BT.2 are each defined by a respective transmit azimuth angular range αT and a respective transmit elevation angular range βT. The transmit beams BT.1, BT.2 comprise transmit azimuth angles αT1, αT2 respectively, which lie within the transmit reference plane RP-T, whereas their transmit elevation angles βT1, βT2 lie within the transmit elevation plane EP-T. The middle axis M-T is the intersecting line of the transmit elevation plane EP-T and the viewing plane VP. The transmit beams BT.1, BT.2 have a first dimension D1 over a transmit elevation angular range βT1, βT2 of particularly 60°. The first dimension D1 is perpendicular to the transmit reference plane RP-T. The transmit beams BT.1, BT.2 have a second dimension D2 perpendicular to the first dimension D1 over a transmit azimuth angular range αT1, αT2 of particularly 10°. Accordingly, the second dimension D2 is significantly smaller than the first dimension D1.

Analogously, the same is valid for the receiver unit 14 except that the refractive beamformer 21 of the receiver unit 14 is associated with a plurality of receive transition structures RTS.1, RTS.2, RTS.3, so that the receiver unit 14 can provide three fan shaped beams BR.1, BR.2, BR.3. FIG. 3 shows two receive beams BR.1, BR.2 which are defined by a receive azimuth angle αR1, αR2 respectively and a receive elevation angle βR1, βR2 respectively. The receive beams BR.1, BR.2 have main directions MDR.1, MDR.2. In the present example they are spaced apart by an azimuth angle φR of about 120°.

Each fan shaped receive beam BR.1, BR.2 is associated with a receive channel RX-1, RX-2 respectively and each fan shaped transmit beam BT.1, BT.2 is associated with a transmit channel TX-Ch1, TX-Ch2 respectively. Exemplarily the transmit beams BT.1, BT.2 and the respective corresponding receive beams BR.1, BR.2 overlap, providing overlap areas OA.1, OA.2, OA.3, OA.4.

Each overlap area OA. 1, OA.2, OA.3, OA.4 corresponds to a sensor azimuth range αS and a sensor elevation range βS. The overlap area OA.1 has the sensor azimuth range αS1 corresponding to the transmit azimuth angle αT1 and the sensor elevation range βS1 which corresponds to the receive azimuth angle αR1. The overlap area OA.2 has the sensor azimuth range αS1 corresponding to the transmit azimuth angle αT1 and the sensor elevation range βS2 which corresponds to the receive azimuth angle αR2. The overlap area OA.3 has the sensor azimuth range αS2 corresponding to the transmit azimuth angle αT2 and the sensor elevation range βS1 which corresponds to the receive azimuth angle αR1. The overlap area OA.4 has the sensor azimuth range αS2 corresponding to the transmit azimuth angle αT2, whereas the sensor elevation range βS2 corresponds to the receive azimuth angle αR2.

In analogy to the first embodiment, a plurality of transition structures TTS.1, TTS.2, RTS.1, RTS.2, RTS.3 at different transition positions 27 are associated with the respective refractive beamformers 20, 21 of the transmitter unit 12 and the receiver unit 14. In contrast to the first embodiment according to FIG. 2 a type of grid is obtained from the overlap areas OA.1, OA.2, OA.3, OA.4 based on the sensor azimuth ranges αS1, αS2 and the sensor elevation ranges βS1, βS2 of the corresponding overlapping beams BT.1, BT.2, BR.1, BR.2. The result information pertaining to the radar result characteristics which are derived from the corresponding overlap areas OA.1, OA.2, OA.3, OA.4 are allocated to pixels of the image fields in order to provide an image of at least a part of the sensor's surrounding space, as described in detail in FIG. 6.

In analogy to the description above, it should be understood, that on account of the third receive beam BR.3, two additional overlap areas are generated. For the sake of clarity, they are not shown in the present example, and they are not explicitly described.

Preferably, the transmit transition structures TTS.1, TTS.2 are switched, i.e. addressed discretely one after the other, to accomplish beam switching. In other words, a transmit signal is applied to one transmit transition structure TTS.1, TTS.2 at a time in successive evaluation cycles. Thus, by controlling the transmit transition structures TTS.1, TTS.2 the angular deviation of the main direction MDT.1, MDT.2 of the transmit beam BT.1, BT.2 is altered relative to the viewing direction, where the angular deviation is in the transmit reference plane RP-T. In each successive evaluation cycle a different discrete transmit transition structure is opened to transmit the signal, allowing it to sweep in the transmit azimuth range in successive evaluation cycles. Beam switching results in a multitude of overlap areas OA.X.

Alternatively, or additionally, two adjacent transmit transition structures TTS.1, TTS.2 can be fed at the same time in a single evaluation cycle. In this case the radar control unit 16 may execute a phase evaluation of the transmit transition structures TTS.1, TTS.2 to potentially correct a phase difference between the adjacent transmit transition structures TTS.1, TTS.2.

Accordingly for example, a sequence of evaluation cycles triggering discrete transition structures TTS.1, TTS.2 and evaluation cycles triggering combined transition structures TTS.1, TTS.2 is possible as well.

FIG. 4 shows a sensor 10 according to the second embodiment described in FIG. 3 in a far field representation showing the angular domains of the overlapping areas OA.1, OA.2, OA.3, OA.4. The sensor 10 comprises a sensor reference plane RP-S which is perpendicular to the viewing plane VP. The sensor elevation plane EP-S is perpendicular to both the sensor reference plane RP-S and the viewing plane VP.

Coordinate systems assigned to the transmitter unit 12 and receiver unit 14 intersect with the sensor's coordinate system X, Y, Z at the origin, i.e. they can be overlayed to correspond to the sensor coordinate system X, Y, Z.

According to the second embodiment, the transmitter unit 12 and the receiver unit 14 are perpendicular to each other, thus the transmit reference plane RP-T and the receive reference plane RP-R intersect each other at an angle of 90°. Consequently, the corresponding beams BT.1, BR. 1 and corresponding beams BT.2, BR.2 are also inclined perpendicular to one another. The transmit beams BT.1, BT.2 and the receive beams BR.1, BR.2 overlap as described in FIG. 3 above, thereby providing a type of grid of overlapping areas OA.1, OA.2, OA.3, OA.4 having the sensor azimuth ranges αS1, αS2 and the sensor elevation ranges βS1, βS2 as explained in FIG. 3. In other words, overlap area OA. 1 corresponding to overlapping beams BT.1, BR.1 has the sensor azimuth range αS1 and the sensor elevation range βS1. Overlap area OA.2 corresponding to overlapping beams BT.1, BR.2 has the sensor azimuth range αS1 and the sensor elevation range βS2. Overlap area OA.3 corresponding to overlapping beams BT.2, BR. 1 has the sensor azimuth range αS2 and the sensor elevation range βS1. Overlap area OA.4 corresponding to overlapping beams BT.2, BR.2 has the sensor azimuth range αS2 and the sensor elevation range βS2.

FIG. 5 shows a top view of the second embodiment of the sensor 10 according to FIG. 3. The transmitter unit 12 and the receiver unit 14 are spaced apart by a distance D. In order for the sensor 10 to detect objects of interest in a part of its surrounding space with high precision, the overlap areas OA.X must lie within a coverage zone of the sensor 10. The coverage zone begins at a manifold of the distance D. For example, the distance D is taken to be the shortest distance between the transmitter and receiver units 12, 14 and the coverage zone starts at a 10-fold of the distance D.

In particular, the transmit reference plane RP-T corresponds to the sensor reference plane RP-S. The sensor reference plane RP-S covers an entire sensor azimuth scope or spectrum, which contains a sensor azimuth angular range αS. The sensor elevation plane EP-S, which is perpendicular to both the viewing direction VD and the sensor reference plane RP-S, covers an entire sensor elevation scope or spectrum, which contains the sensor elevation angular range βS, and is not depicted from the shown perspective.

The radar control unit 16 addresses two transmit transition structures TTS.1, TTS.2 which transmit electromagnetic signals, such that transmit beams BT.1, BT.2 are generated by the refractive beamformer 20, which is designed to collimate electromagnetic energy on account of its physical properties. Thus, each transition structure TTS.1, TTS.2 correlates with a respective fan shaped beam BT.1, BT.2, where the beams BT.1, BT.2 represent angular regions of fan shaped radiation patterns, as explained in FIG. 7.

The position and/or orientation of the transmit transition structures TTS.1, TTS.2 relative to the refractive beamformer 20 is responsible for the main direction MDT.1, MDT.2 in which the electromagnetic signal propagates. The main direction MDT.1, MDT.2 of energy propagation lies in the transmit reference plane RP-T, which correlates with the sensor reference plane RP-S.

The transmit beams BT.1, BT.2 each comprise a transmit azimuth angle αT1, αT2 being relevant to a sensor azimuth angular range αS1, αS2 respectively. The transmit beams BT.1, BT.2 each extend over transmit elevation angles βT1, βT2, correlating with the sensor elevation angular ranges βS1, βS2 which are not shown in this perspective.

FIG. 5 shows that the echo wave of transmit beam BT.1, which correlates with receive beam BR.1, is received by the receiver unit 14. The receive transition structure RTS.1 (not shown) associated with the refractive beamformer 21 receives an electromagnetic signal coming from a specific direction correlating with the receive beam BR.1. According to the second embodiment, the transmitter and receiver units 12, 14 are orthogonal to each other. Consequently, the corresponding beams BT.1, BR.1 are also inclined perpendicular to one another. The receive beam BR.1 is perpendicular to the receive reference plane RP-R and comprises a receive elevation angle βR1 which corresponds to about 60° and a receive azimuth angle αR1 of about 10°, which is not shown from this perspective. Since the receive 14 unit is perpendicular to the transmitter unit 12, the receive elevation angle βR1 corresponds to a sensor azimuth range αS and the receive azimuth angle αR1 corresponds to a sensor elevation range βS.

FIG. 5 shows exemplarily that the overlap area OA. 1 is formed by transmit beam BT.1 overlapping with receive beam BR. 1, where the overlap area OA. 1 is depicted by an intersection line on account of the perspective of the diagram. The overlap area OA. 1 relates to the sensor azimuth ranges αS and sensor elevation range βS of the respective beams BT.1, BR. 1. As explained in FIG. 3 above, the overlap area OA.1 comprises the sensor azimuth range αS1 and the sensor elevation range βS1, where the sensor azimuth range αS1 corresponds to the transmit azimuth angle αT1 and is depicted by the intersection line in FIG. 5 and where the sensor elevation range βS1 corresponds to the receive azimuth angle αR1, which is not shown from this perspective.

Each beam BT.1, BT.2, BR.1 shown in FIG. 5 exhibits a first dimension D1 which is perpendicular to the reference plane RP-T, RP-R of the respective refractive beamformer 20, 21. The first dimension D1 corresponds to a beam height being relevant to the respective refractive beamformer 20, 21. In the example shown, the first dimension D1 of the receive beam BR.1 is perpendicular to the receive reference plane RP-R and extends over the receive elevation range βR1 which comprises about 60° and which corresponds to a sensor azimuth range αS.

Analogously, the transmit beams BT.1, BT.2 have a first dimension D1, which is perpendicular to the reference plane RP-T of the respective refractive beamformer 20 and corresponds to a beam height being relevant to the transmit elevation angular range of the refractive beamformer 20. Thus, the first dimension D1 of transmit beams BT.1, BT.2 is relevant to the transmit elevation angles βT1, βT2 (not shown) of the refractive beamformer 20 and hence to sensor elevation range βS (not shown).

Each beam BT.1, BT.2, BR.1 also comprises a second dimension D2 being perpendicular to the first dimension D1 and corresponding to a beam width relevant to an azimuth angle of the respective refractive beamformer 20, 21. The second dimension of transmit beams BT.1, BT.2 extends over the transmit azimuth angles αT1, αT2, each corresponding to about 10° and relating to a sensor elevation range αS1, αS2. Analogously, the second dimension D2 of receive beam BR.1, which is not depicted from this perspective, extends over the receive azimuth angle αR1 (not shown) which relates to sensor elevation range βS (not shown).

FIG. 6 shows multiple overlap areas OA.X provided when corresponding fan shaped beams BT.1-BT.4, BR.1-BR.6 overlap, thus forming a type of grid, which enables an image of at least a part of the sensor's surrounding space to be generated by allocating information to the individual overlap areas OA.X.

By way of example FIG. 6 specifically describes the embodiment shown in FIG. 3, where transmit beams BT.1, BT.2 overlap with corresponding receive beams BR.1, BR.2, thereby providing overlap areas OA.1, OA.2, OA.3, OA.4. Additional transmit and receive beams BT.3, BT.4, BR.3, BR.4, BR.5, BR.6 are depicted in order to show that a high resolution can be achieved. By analogy, the description referring to transmit beams BT.1, BT.2 overlapping with corresponding receive beams BR.1, BR.2, is valid for all corresponding beams BT.1, BT.2, BT.3, BT.4, BR.1, BR.2, BR.3, BR.4, BR.5, BR.6 shown in the grid and their respective overlap areas OA.X provided.

The grid includes transmit beams BT.1, BT.2 which have a first dimension D1 perpendicular to their respective transmit reference plane RP-T. The first dimension D1 ranges over a transmit elevation angular range βT of particularly 120°.

The fan shaped beams BT.1, BT.2 each have a second dimension D2 which is perpendicular to the first dimension and extends over transmit azimuth angular ranges αT1, αT2 of particularly 10° relating to the sensor azimuth range αS. In particular, the transmit beams BT.1, BT.2 each correspond to a sensor azimuth range αS1, αS2 each corresponding to about 10°. Accordingly, the second dimension D2 is significantly smaller than the first dimension D1.

Analogously, the same is valid for the receive beams BR.1, BR.2, which have a first dimension D1 which is perpendicular to the respective reference plane RP-R and extends over a receive elevation range βR1, βR2 of about 120° with respect to the receive reference plane RP-R. The receive beams BR.1, BR.2 have a second dimension D2 which is perpendicular to the first dimension D1 and extends over the respective receive azimuth angular range αR1, αR2, each being about 10°. The receive reference plane RP-R is perpendicular to the transmit reference plane RP-T, which corresponds to the sensor reference plane RP-S. Therefore, receive beams BR.1, BR.2 show receive elevation angular ranges βR1, βR2 which are contained in the sensor azimuth scope and the receive beams BR.1, BR.2 have receive azimuth angular ranges αR1, αR2 which are contained in the sensor elevation scope, and correspond to the sensor elevation ranges βS1, βS2.

As described in detail in FIG. 3 above, the overlap areas OA.1, OA.2, OA.3, OA.4 can each be defined by a sensor azimuth range αS1, αS2 and the sensor elevation range βS1, βS2 associated with the corresponding beams BT.1, BT.2, BR.1, BR.2, as listed in the table in FIG. 6. In other words, corresponding beams BT.1, BR. 1 relate to the sensor azimuth range αS1 and the sensor elevation range βS1, thereby defining the overlap area OA.1. The transmit beam BT.1 overlaps with receive beam BR.2, generating overlap area OA.2 defined by the sensor azimuth range αS1 and the sensor elevation range βS2. Corresponding beams BT.2, BR.1 generate overlap area OA.3, which is therefore defined by the sensor azimuth range αS2 and the sensor elevation range βS1. Corresponding beams BT.2, BR.2 relate to the sensor azimuth range αS2 and the sensor elevation range βS2, thereby defining the overlap area OA.4.

Each of the corresponding beams BT.1, BT.2, BR.1, BR.2 is associated with a respective transmit and receive transition structure TTS.1, TTS.2, RTS.1, RTS.2, which in turn is associated with a respective transmit and receive channel TX.1, TX.2, RX.1, RX.2. In other words, the sets of corresponding beams BT.1, BR.1; BT.1, BR.2; BT.2; BR.1; BT.2, BR.2 are associated with paired transmit and receive channels TX.1, RX.1; TX.1, RX.2; TX.2, RX.1; TX.2, RX.2. Thus, referring to the table in FIG. 6, the sensor azimuth range αS of transmit beams BT.1, BT.2 and the sensor elevation range βS of receive beams BR1, BR.2 defining the overlap areas OA.1, OA.2, OA.3, OA.4, can be related to the respective receive channels RX.1, RX.2, which are paired with a corresponding transmit channels, TX.1, TX.2. in other words, during each evaluation cycle, the radar control unit establishes a relation between the individually addressed transmit channel TX.1, TX.2 and the set of receive channels RX.1, RX.2 having received signals from the echo wave.

Further, each overlap area OA.1, OA.2, OA.3, OA.4 is associated with a radar result characteristic provided by the receive channel RX.1, RX.2 whose receive beam BR.1, BR.2 overlaps with the transmit beam BT.1, BT.2 of the transmit channel TX. 1, TX.2. The radar result characteristic, which may include amplitude, frequency, phase, etc., is processed to determine result information I-1, I-2, I-3, I-4, which can then be assigned to the corresponding receive channel RX.1, RX.2 and therefore to the respective overlap area OA.1, OA.2, OA.3, OA.4 corresponding to the respective paired transmit-receive channels TX.1, RX.1; TX.1, RX.2; TX.2, RX.1; TX.2, RX.2.

In summary, the result information I-1, I-2, I-3, I-4 is due to a specific pair of overlapping transmit and receive beams BT.1, BT.2, BR.1, BR.2 which generate specific overlap areas OA. 1, OA.2, OA.3, OA.4 associated with respective sensor azimuth and sensor elevation ranges αS, βS. The relations are mapped in a predefined way in the data memory 32 and the imaging unit 18 uses the mapping information to assign the result information I-1, I-2, I-3, I-4 to the overlap areas OA.1, OA.2, OA.3, OA.4 which correspond to a predefined relation of transmit and receive channels TX. 1, TX.2, RX. 1, RX.2. Thus, an image of at least a part of the sensor's surrounding space can be created from the grid of overlap areas OA.1, OA.2, OA.3, OA.4 and the result information I-1, I-2, I-3, I-4. The value and/or changes in values relating to the result information may be coded, e. g. colour-coded, enabling a pixel image to be created by using graphic image processing and/or filter algorithms.

FIG. 7 shows an example of a fan shaped transmit beam BT.1 being a region of a fan shaped radiation pattern 44 associated with a transmit transition structure TTS.X of the transmitter unit 12 on account of the cylindrical refractive beamformer 20. For ease of reference the fan shaped radiation pattern 44 is shown in a coordinate system X, Y, Z, preferably of the transmitter unit 12, where X depicts a rotation axis with respect to the transmit elevation angular range βT and Y depicts a rotation axis with respect to the transmit azimuth angular range αT. The reference plane RP-T lies in the X-Z plane and the transmit elevation plane EP-T lies in the Y-Z plane and is perpendicular to the reference plane RP-T.

The fan shaped radiation pattern 44 radiates energy predominantly in one direction which is the main direction MDT.1, whereas energy is radiated marginally in other directions. The main direction MDT.1 of the signal depends on the positioning of the respective transmit transition structure TTS. 1 which is not shown.

The angular region of the fan shaped radiation pattern 44 which represents the fan shaped transmit beam BT.1 is less than a threshold value below the maximum gain amplitude of the radiation pattern 44. The threshold value may, for example, range between 3 dB and 10 dB. In the example shown, the threshold value corresponds to 3 dB. Thus, the transmit azimuth range αT of the beam BT.1 is narrow, e.g. 10°, whereas the transmit elevation range βT is wider, e.g. 60°.

Thus, the beam BT.1 comprises a first dimension D1 which in this case is six times larger than the second dimension D2. The first dimension D1 is perpendicular to the reference plane RP-T and to the second dimension D2, which includes the direction of peak gain. The main direction MDT.1 of energy propagation lies in the reference plane RP-T.

FIG. 8 shows how the microwave imaging radar sensor 10 functions in detail to provide an image of at least a part of its surrounding space. The sensor 10 comprises at least one transmitter unit 12 coupled with a receiver unit 14, as well as an evaluation unit 15 comprising a radar control unit 16 and an imaging unit 18.

The radar control unit 16 comprises a transmission chain relaying information from the imaging unit 18 to the transmitter unit 12. The radar control unit 16 comprises an interface 30 to which the imaging unit 18 is connected.

The imaging unit 18 comprises a computational unit 31 that sets information signals which are communicated to the radar control unit 16 via the interface 30. The signals are allocated to a respective transmit channel TX.X. In other words, the imaging unit 18 provides a set of signals determining which of a plurality of transmit transition structures TTS.X are to be addressed by the radar control unit 16 in a single evaluation cycle in order to emit transmit beams BT.X, and which transmit characteristics TC are to be transmitted by the addressed transmit transition structures TTS.X. Said information, namely the transmit transition structure TTS.X and the related transmit characteristic TC, is stored in a transmit information map 35a, for example, and it is accessible to the computational unit 31, such that the interface 30 can relay a transmit specification TTS.X.-TC to the radar control unit 16.

The computational unit 31 can comprise a CPU and/or FPGA and/or ASIC and/or a Microprocessor.

The imaging unit 18 comprises a data memory 32 which stores a mapping information, consisting of a plurality of predetermined relations between the transmit channels TX.X and the receive channels RX.X and the respective overlap areas OA.X, particularly overlap area coordinates pertaining to sensor azimuth ranges αS and sensor elevation ranges βS as described in FIG. 6. The data memory 32 preferably also comprises a plurality of mapping information each related to a specific angle between the transmit reference plane RP-T and the receive reference plane RP-R, allowing for flexible adjustment of the resolution of the sensor 10.

The imaging unit 18 conveys the transmit specification TTS.X-TC to the radar control unit 16, which has an input port 34 to receive these signals from the imaging unit 18 via the interface 30. The imaging unit 18 can instruct the radar control unit 16 to execute a plurality of evaluation cycles, where for each evaluation cycle the addressed transmit transition structure TTS.X and the associated transmit characteristic TC are allocated to a specific transmission channel TX.X. The computational unit 31 of the imaging unit 18 executes cycles for each transmit channel TX.X present in the mapping information, which is stored in the data memory 32. For each transmit channel TX.X the information of the transmit information map 35a of the corresponding transmit channel TX.X is used to apply the related transmit characteristic TC to the related transmit transition structure TTS.X.

In each evaluation cycle the radar control unit 16 outputs the transmit signal by addressing a particular transmit transition structure TTS.X to transmit a microwave having transmit characteristics TC. The transition structure TTS.X directs a microwave into the refractive beamformer 20 of the transmitter unit 12, generating a fan shaped radiation pattern 44 which comprises a fan shaped beam BT.X.

A plurality of transmit transition structures TTS.X can preferably be addressed discretely one after the other in successive evaluation cycles, such that microwaves are fed into the refractive beamformer 20 discretely at multiple transition positions 27. By triggering the transmit transition structures TTS.X one after another multiple beams are generated singly, each having a main direction oriented broadly in the viewing direction, thereby sweeping the azimuth scope or spectrum of the refractive beamformer 20 of the transmitter unit 12 in successive evaluation cycles.

Each transmitted microwave comprises electromagnetic energy which is directed predominantly in a desired direction being the main direction. The microwave provides specific transmit characteristic TC. An object of interest reflecting the transmitted microwave provides an echo wave which is associated with a receive beam BR.X and can be picked up by the refractive beamformer 21 of the receiver unit 14. The echo wave has an altered characteristic compared to the transmitted microwave.

By reciprocity, the radar control unit 16 comprises a receiving chain that relays information from the receiver unit 14 to the imaging unit 18. The echo wave is picked up preferably by a plurality of receive transition structures RTS.X, each associated with a receive channel RX.X. The radar control unit 16 evaluates the receive signal based on the corresponding transmit signal and generates a result signal having a radar result characteristic RC. The radar result characteristic RC is related to a specific receive transition structure RTS.X. Said information, namely a receive evaluation RTS.X-RC, comprising the evaluated receive transition structure RTS.X related to a specific radar result characteristic RC, is output by the radar control unit 16 via its output port 36 and relayed to the imaging unit 18 via the interface 30.

Preferably, the radar control unit 16 uses analogue processing to transmit electromagnetic energy by triggering the addressed transmit transition structures TTS.X and to evaluate the set of receive transition structures RTS.X receiving the echo or receive signals. The relation between the receive transition structures RTS.X and the receive channels RX.X is stored in a receive information map 35b.

The radar control unit 16 has an output port 36 to output the radar result characteristics RC related to an evaluated receive transition structure RTS.X, i.e. the receive evaluations RTS.X.-RC, to the imaging unit 18 via the interface 30.

The imaging unit 18 receives the radar result characteristics RC and the related receive transition structures RTS.X in each evaluation cycle and processes the radar result characteristic to determine the result information I.X associated with the receive transition structures RTS.X. The radar result characteristic RC can preferably be digitally processed to obtain the result information I.X.

The result information I.X is associated with a receive transition structure RTS.X, and hence it relates to a receive channel RX.X, based on the receive information map 35b. Thus, the computational unit 31 assigns the result information I.X to the corresponding receive channel RX.X by accessing the receive information map 35b. The transmit information map 35a and/or the receive information map 35b can be separately stored or incorporated into the mapping information stored in the data memory 32.

Using the mapping information in the data memory 32, the computational unit 31 of the imaging unit 18 relates the receive channel RX.X to the corresponding transmit channel TX.X, preferably by digital processing, and it assigns the result information I.X to the respective overlap area OA.X corresponding to the pair of transmit-receive channels TX.X, RX.X for each evaluation cycle, thereby creating an image of at least a part of the sensor's surrounding space. In particular, a raw data image can be created from the grid of overlap areas OA.X.

The imaging unit 18 comprises an output port 38 enabling it to output the image to an image processing unit 40. The image processing unit 40 can be part of a sensor containing the microwave imaging radar sensor 10 in a common housing. The image processing unit 40 analyses the image further to recover a processed image.

The image has a multitude of fields, where each field is represented by a pixel which correlates to a specific relation, where a relation corresponds to a specific receive channel RX.X being assigned to a specific transmit channel TX.X. Each pixel is assigned a value related to the result information I.X.

For instance, in a processed image a value and/or changes in values allocated to each pixel can be coded, e. g. grey-coded, colour-coded, etc. enabling a pictorial image to be made by using graphic image processing and/or filter algorithms. It is also possible to create a variety of other images, e.g. a 3D cartesian-image by taking into account the result of signal processing applied on the result information I.X based on the radar result characteristics RC.

FIG. 9 shows a part of a sensor 10 having a transmitter unit 12 which comprises a refractive beamformer 20 being a cylindrical lens that is enclosed in a mechanical housing 42 of which a sectional cut is shown.

The setup of the implementation of the transmitter unit 12 is the same as without the mechanical housing 42 and analogous to that of the receiver unit 14.

In the present example, the transmitter unit 12 is embodied in a single circuit board 25, e.g. a PCB-body 26, which has a plurality of core layers 22 comprising a dielectric substrate. The core layers 22 are attached to each other by a prepreg layers 46 and are enclosed by top and bottom metallized layers 23 confining the dielectric substrate, giving it structural support and providing focusing properties of the refractive beamformer 20 in an elevation direction.

The core layers 22 in the transmitter unit 12 form the respective refractive beamformer 20, which has a cylindrical shape, allowing it to transmit fan-shaped beams. The dielectric core substrate of the transmitter unit 12 works as a lens, particularly a gradient index lens. The dielectric index is influenced by holes 29 through the dielectric core layers 22.

On account of the circuit board 25 comprising multiple core layers 22, the transmit transition structures TTS.X, which are associated with the refractive beamformer 20 at different transition positions 27, can be a waveguide 48 and a probe 49 embodied as a blind via. The transmit transition structures TTS.X are able to convert electrical energy into electromagnetic energy, i.e. a microwave, which is then directed to the refractive beamformer 20 by the waveguide 48.

The waveguide 48 is integral to the single circuit board 25. It is confined by the metallized top and bottom layers 23 and by side walls 50a, 50b, which are formed by metallized vias which connect the metallized layers 23 by traversing the core layers 22, enabling the waveguide 48 to direct the electromagnetic energy in a particular direction.

The transition lines 24 are connected to the radar control unit 16 as described previously.

The housing 42 of the refractive beamformer 20 is preferably made of a dielectric substrate and exhibits a torus-like shape. At opposing poles, the housing 42 has an open surface around its central axis of rotation, which corresponds to the middle axis M-T of the transmitter unit 12. In the present example, the toroidal housing 42 has a central hyperboloid removed from it, such that opposing poles of the housing 42 are open surfaces. Thus, the cylindrical lens is radially enclosed by the housing 42, whereas both flat circular surfaces of the cylindrical lens are only partially enclosed by the housing 42 around the edges.

As a result of its curvature and its dielectric property, the housing 42 affects the polarization properties of the electromagnetic radiation transmitted and received. Advantageously the housing 42 is able to convert planar electromagnetic radiation into radiation with circular polarization, which is preferred when analysing RF waves echoing from irregular objects, as circularly polarised waves are able to collect more energy from various echoes for transmitting. For example, human bodies do not always maintain a linear polarization when they produce an echo, thus the detection sensitivity of the sensor 10 can be enhanced by the torus-like housing 42.

It is conceivable that the lens housing 42 is an integral part of a housing of the sensor 10. The integral housing may be produced as a single piece, e.g. by 3D printing with the same material, such that the dielectric property is the same throughout the housing. Alternately, it is possible that a part interconnecting the sensor housing with the lens housing 42 has a different dielectric property compared to the lens housing 42.

### List of Reference Signs

10 microwave imaging radar sensor
12 transmitter unit
14 receiver unit
15 evaluation unit
16 radar control unit
18 imaging unit
20 refractive beamformer
21 refractive beamformer
22 core layer
23 metal layer
24 transmission line
25 circuit board
26 PCB-body
27 transition position
28 connecting region
29 holes
30 interface
31 computational unit
32 data memory
34 input port RCU
35a transmit information map
35b receive information map
36 output port RCU
38 output port IU
40 image processing unit
42 housing
44 radiation pattern
46 prepreg layer
48 waveguide
49 probe
50a side wall
50b side wall
αR receive azimuth angular range
αS sensor azimuth angular range
αT transmit azimuth angular range
βR receive elevation angular range
βS sensor elevation angular range
βT transmit elevation angular range
φR azimuth angle included between receive beams
φT azimuth angle included between transmit beams
BR.X receive beam
BT.X transmit beam
D distance
D1 first dimension
D2 second dimension
EP-R Receive elevation plane
EP-S Sensor elevation plane
EP-T transmit elevation plane
I.X result information
M-T middle axis transmitter unit
M-R middle axis receiver unit
MDR.X main direction receive beam
MDT.X main direction transmit beam 1
OA.X overlap area
RC radar result characteristic
RP-R receive reference plane
RP-S sensor reference plane
RP-T transmit reference plane
RTS.X receive transition structure
RTS.X-RC receive evaluation
RX.X receive channel
TTS.X transmit transition structure
TTS.X-TX transmit specification
TX.X transmit channel
VD viewing direction
VP viewing plane

1. A microwave imaging radar sensor for creating an image of at least a part of its surrounding space, where the sensor comprises at least one transmitter unit, a receiver unit and an evaluation unit which has an output port to output an image and which is connected to the transmitter unit and the receiver unit, where the image comprises fields, where the fields are related to a pair of a transmit channel (TX.X) and a receive channel (RX.X), where at least two transmit channels (TX.X) and at least two receive channels (RX.X) each correspond to a fan shaped beam (BT.X, BR.X) having a first dimension (D1) which is significantly larger than a second dimension (D2) and where the first dimension (D1) is perpendicular to the second dimension (D2), where the field is assigned to a radar result characteristic (RC) provided by the receive channel (RX.X) whose fan shaped receive beam (BR.X) overlaps with the fan shaped transmit beam (BT.X) of the transmit channel (TX.X) defining an overlap area (OA, OA.X), wherein the transmit channel (TX.X) correlates with the transmitter unit, which comprises a refractive beamformer comprising a transmit reference plane (RP-T) to which the fan shaped transmit beams (BT.X) of the transmit channels (TX.X) are perpendicular with their first dimension (D1), where the transmitter unit comprises a plurality of transmit transition structures (TTS.X) associated with the refractive beamformer at different transition positions, so that each transmit channel (TX.X) is related to at least one transmit transition structure (TTS.X), and where the receive channel (RX.X) correlates with the receiver unit that comprises a refractive beamformer comprising a receive reference plane (RP-R) to which the fan shaped receive beams (BR.X) of the receive channels (RX.X) are perpendicular with their first dimension (D1), where the receiver unit comprises a plurality of receive transition structures (RTS.X) associated with the refractive beamformer at different transition positions, so that each receive channel (RX.X) is related to at least one receive transition structure (RTS.X).

2. The microwave imaging radar sensor according to claim 1, wherein the evaluation unit comprises a radar control unit and an imaging unit being connected to each other, where the radar control unit is connected to the transmitter unit and the receiver unit by transmission lines, and where the imaging unit comprises the output port.

3. The microwave imaging radar sensor according to claim 2, wherein the transmit and/or receive transition structure (TTS.X, RTS.X) relays electrical energy between the transmission line and a waveguide, where the waveguide propagates electromagnetic energy between the transmit and/or receive transition structure (TTS.X, RTS.X) and the respective refractive beamformer.

4. The microwave imaging radar sensor according to claim 2, wherein the radar control unit sends a signal to a transmit transition structure (TTS.X) or a combination of a plurality of transmit transition structures (TTS.X) to transmit a transmit signal related to a specific transmit channel (TX.X), where the radar control unit receives a receive signal of a corresponding echo received by the receive transition structures (RTS.X) and determines the radar result characteristics (RC) of the receive signals, where the radar control unit comprises an interface having an input port and an output port, where the input port receives the specification of the transmit transition structures (TTS.X) to be addressed and the signal characteristics to be provided to the addressed transmit transition structures (TTS.X) of the transmitter unit related to the transmit channel (TX.X), and the output port outputs a set of radar result characteristics (RC) related to the evaluated receive transition structures (RTS.X) of the receiver unit related to the receive channel (RX.X).

5. The microwave imaging radar sensor according to claim 1, wherein the sensor comprises a viewing direction (VD) to which a viewing plane (VP) is perpendicular, where the sensor comprises a sensor reference plane (RP-S) which is perpendicular to the viewing plane (VP), and where the transmit reference plane (RP-T) and the receive reference plane (RP-R) are perpendicular are to the viewing plane (VP).

6. The microwave imaging radar sensor according to claim 1, wherein the fan shaped beam (BT.X, BR.X) comprises a main direction (MDT.X, MDR.X) which is the direction of peak gain, where the main direction (MDT.X, MDR.X) is dependent on the positioning of the transition structure (TTS.X, RTS.X) relative to the respective refractive beamformer, where at least two fan shaped beams (BT.X, BR.X) of both the transmitter unit and the receiver unit each comprise a main direction (MDT.X, MDR.X) which is oriented broadly in the viewing direction (VD), so that at least two fan shaped beams (BT.X, BR.X) of both the transmitter unit and the receiver unit overlap each other at least partially in the overlap areas (OA, OA.X).

7. The microwave imaging radar sensor according to claim 2, wherein the imaging unit is connected to the interface of the radar control unit and sets the input of the radar control unit to address a specific combination of transmit channels (TX.X) and receives the set of radar result characteristics (RC) of the evaluated receive channels (RX.X) and creates the image by relating the received radar result characteristics (RC) to a field by taking into account the addressed transmit channel (TX.X) and the corresponding receive channel (RX.X).

8. The microwave imaging radar sensor according to claim 1, wherein the refractive beamformer is a dielectric lens.

9. The microwave imaging radar sensor according to claim 8, wherein the dielectric lens is a gradient index lens.

10. The microwave imaging radar sensor according to claim 9, wherein the gradient index lens is a cylindrical generalized Luneburg lens.

11. The microwave imaging radar sensor according to claim 10, wherein the reference plane (RP-T, RP-R) for the cylindrical generalized Luneburg lens is perpendicular to the middle axis (M-T, M-R) of the lens.

12. The microwave imaging radar sensor according to claim 10, wherein the cylindrical generalized Luneburg lens has a permittivity gradient which varies as a square law of the radial position.

13. The microwave imaging radar sensor according to claim 1, wherein the receive reference plane (RP-R) of the receiver unit and the transmit reference plane (RP-T) of the transmitter unit intersect, where the intersection angle is between 0° and 90°; 0°≤intersection angle≤90°.

14. The microwave imaging radar sensor according to claim 13, wherein the intersection angle is between 15° and 90° so that a monitoring grid can be formed.

15. The microwave imaging radar sensor according to claim 2, wherein the radar control unit comprises a receiving chain that is connected to the receiver unit, so that the radar control unit determines the signal characteristics received via a plurality of receive transition structures (RTS.X), where furthermore the radar control unit comprises a transmission chain that is connected to the transmitter unit, so that the imaging unit can address a plurality of transmit transition structures (TTS.X) with a transmit signal.

16. The microwave imaging radar sensor according to claim 2, wherein the radar control unit carries out at least one evaluation cycle in which a relation is established between the addressed transmit transition structure (TTS.X) and the evaluated receive transition structure (RTS.X).

17. The microwave imaging radar sensor according to claim 2, wherein the imaging unit comprises a data memory which stores a plurality of relations between the transmit transition structure (TTS.X) and the receive transition structure (RTS.X).

18. The microwave imaging radar sensor according to claim 2, wherein the imaging unit outputs the image to an image processing unit which maps the image of at least a part of the sensor's surrounding space as a grid consisting of a plurality of pixels which are stored in the data memory, where each pixel is assigned to a relation between the transmit transition structure (TTS.X) and the receive transition structure (RTS.X).

19. The microwave imaging radar sensor according to claim 3, wherein the transmit signal and the radar result characteristics (RC) are generated by FMCW.

20. The microwave imaging radar sensor according to claim 1, wherein radar result characteristics (RC) are generated by evaluating the receive signal with respect to the transmit signal using the Doppler-effect.

21. The microwave imaging radar sensor according to claim 1, wherein the transmit channels (TX.X) are switched to accomplish beam switching, where a transmit signal is applied to one transmit channel (TX.X) at a time for each evaluation cycle, where each transmit channel (TX.X) refers to one transmit transition structure (TTS.X) or a plurality of transmit transition structures (TTS.X), in particular adjacent transmit transition structures (TTS.X).

22. The microwave imaging radar sensor according to claim 2, wherein the receiver unit, the transmitter unit and the transmission lines are implemented as a single circuit board.

23. The microwave imaging radar sensor according to claim 22, wherein the single circuit board comprises a PCB-body comprising at least one core layer, where the PCB-body has at least one metallized layer at the top and at the bottom of the PCB-body.

24. The microwave imaging radar sensor according to claim 23, wherein the at least one core layer is made of a dielectric substrate, where the core layer of the transmitter unit and the receiver unit forms the respective refractive beamformer having a curved contour.

25. The microwave imaging radar sensor according to claim 23, wherein the at least one waveguide is integral to the single circuit board and is confined by the metallized top and bottom layer of the PCB-body and by metallized vias connecting the metallized layers, thereby acting as side walls of the waveguide.

26. The microwave imaging radar sensor according to claim 22, wherein the radar control unit is attached to the single circuit board and is connected to the transmit and receive transition structures (TTS.X, RTS.X).

27. The microwave imaging radar sensor according to claim 1, wherein the refractive beamformer is covered by a lens housing to provide radiation of circular polarization.

28. The microwave imaging radar sensor according to claim 1, wherein the refractive beamformer is a cylindrical lens, where the lens is enclosed in a torus-shaped lens housing having a first dielectric property and having an open surface around its central axis of rotation (M-T, M-R) at the top and at bottom poles.

29. The microwave imaging radar sensor according to claim 26, characterized in that the lens housing is integrated in a housing of the sensor.

30. The microwave imaging radar sensor according to claim 1, wherein the microwave imaging radar sensor comprises a plurality of transmitter units and/or a plurality of receiver units that are connected to the evaluation unit.
